(19) United States
(12) Patent Application Publication
(10) Pub. No.: US 2025/0184565 A1
(43) Pub. Date: Jun. 5, 2025

(54) SYSTEMS AND METHODS FOR DELIVERING APPLICATION CONTENT TO A COMPUTING DEVICE

(71) Applicant: Adeia Guides Inc., San Jose, CA (US)

(72) Inventors: Charles Dasher, Lawrenceville, GA (US); Christopher Phillips, Hartwell, GA (US); Serhad Doken, Bryn Mawr, PA (US); Tao Chen, Palo Alto, CA (US); Cato Yang, San Jose, CA (US)

(21) Appl. No.: 18/528,400

(22) Filed: Dec. 4, 2023

(51) Int. Cl. H04N 21/434; H04N 21/438; H04N 21/81

(52) U.S. Cl. CPC H04N 21/4349; H04N 21/4384; H04N 21/812

(57) ABSTRACT

Systems and methods are provided for delivering application content to a computing device via a carousel of a unidirectional stream. An application identifier is received, at a computing device and via a carousel of a unidirectional stream, and content associated with an application identified by the application identifier is received via the carousel. It is identified that the application is installed at the computing device, and the received content is stored at a memory associated with the computing device. A notification associated with the application is output, and an input associated with the notification is received. The received content is generated for output via the application.

### FIELD OF THE DISCLOSURE

One or more disclosed embodiments are directed towards systems and methods for delivering application content to a computing device via a broadcast of a unidirectional stream.

### SUMMARY

With the availability of smart, or connected, televisions, there is an expectation that televisions can receive and display content from multiple sources. This includes traditional broadcast content as well as over-the-top (OTT) content that is received via the internet. The broadcast content may be received terrestrially or over-the-air (OTA), via satellite, and/or via cable. In addition, many smart televisions are able to install applications that receive the OTT content via the internet, and generate the OTT content for display at the smart television. Typically, these applications are either preinstalled on the smart television, or are available for download via the internet. In any case, the applications typically receive the OTT content itself via the internet. As such, if a smart television is not connected to the internet, most (if not all) smart functionality, such as the ability to consume OTT content or otherwise receive and process OTT data via one or more installed applications is lost. Although most households have an internet connection, these household internet connections vary widely in both bandwidth and quality. In some cases, the available bandwidth and/or speed of the internet connection may not be sufficient to deliver content to an application installed on a smart television. Furthermore, internet connections may have data restrictions, or caps, applied to them. As streaming content via an application running on the smart television can consume a large amount of bandwidth, any such data restriction may be reached relatively quickly. In other scenarios, a user may be attempting to use an OTT application to stream content on a smart television at a remote location with bad internet service, for example, when traveling or camping. In a further example, in some countries, a home broadband service may be expensive or less available. Users may have a cellular service; however, the cellular service may be slow and not generally suitable for OTT content consumption. Even though the home broadband and cellular services may be unsuitable for OTT consumption, a user may still own a smart television with OTT apps preinstalled. In order to enable applications on a smart television to continue to function when there is no internet connection, or when there is a limited or intermittent internet connection, there is a need to enable techniques for receiving data associated with smart television applications from a source other than the internet.

To help address these problems, systems and methods are provided for enabling application data to be transmitted via a unidirectional stream. In accordance with some aspects of the disclosure, a method is provided that includes receiving, at a computing device and via a carousel of a unidirectional stream, an application identifier. Content associated with an application identified by the application identifier is received via the carousel, and it is identified that the application is installed at the computing device. The received content is stored at a memory associated with the computing device, and a notification associated with the application may be provided as an output. An input associated with the notification may then be received, and the received content generated for output via the application.

In an example system, a computing device, such as a smart television, receives one or more broadcast channels from an entity, such as ABC or the Disney Channel, via an OTA broadcast. The Disney Channel may comprise broadcast audiovisual content that is received and displayed at the smart television. An application identifier for an OTT application controlled by the entity (e.g., a Disney Plus or Disney+ application) may be received via a carousel that is broadcast with the Disney Channel. An on-demand Disney+ episode for viewing via the application, such as season one, episode one of “The Mandalorian,” may also be received at the smart television via the OTA broadcast. In an embodiment, the data for the on-demand program is multiplexed with the data for the broadcast audiovisual program. On identifying that the Disney+ app is installed at the smart television, the received data for season one, episode one of “The Mandalorian” may be stored at non-volatile memory of the smart television. In this embodiment, once data has been received for the whole episode, a notification may be displayed at the television indicating that the episode is available to view via the Disney+ application. On receiving a selection of the notification, season one, episode one of “The Mandalorian” is displayed at the smart television.

Broadcast content may be received at the computing device via the unidirectional stream, and the application identifier may identify an application associated with the broadcast content.

It may be identified that the application identified by the application identifier is not installed at the computing device. Data for installing the application may be received, and the application may be installed via the received data and at the computing device.

A trigger for outputting the notification may be identified, and outputting the notification associated with the application may further comprise outputting the notification in response to identifying that the trigger has occurred.

A start time for tuning the computing device or television to the unidirectional stream may be identified, and it may be identified that a current time corresponds to the start time, and in response the computing device may be tuned to the unidirectional stream.

The content may be first content, and storing the received first content at the memory may further comprise storing the received first content to a first content file. A discontinuity indicator flag may be received at the computing device and via the carousel. Second content associated with the application may be received via the carousel, and the received second content may be stored at the memory associated with the computing device.

The carousel may be a first carousel, and the unidirectional stream may be a first unidirectional stream. The first carousel and the first unidirectional stream may be received via a first tuner of the computing device, and broadcast content may be received via a second unidirectional stream via a second tuner of the computing device.

The unidirectional stream may comprise broadcast content multiplexed with the content associated with the OTT application, and a content identifier may be received at the computing device and via the carousel, where the content identifier may identify whether each of the broadcast content and the content associated with the OTT application should be output at the computing device or should be stored at the memory associated with the computing device.

A popularity associated with each installed application may be identified for each of a plurality of applications installed at the computing device. A portion of the memory associated with the computing device may be assigned to each of the plurality of installed applications, where a size of each of the assigned portions is based on the popularity of a respective application.

The received content may comprise first content and second content, where the first content may comprise an advertisement, and the second content may not comprise an advertisement. It may be identified that a threshold amount of advertisement-supported broadcast content has been consumed at the computing device, and generating the received content for output may further comprise generating the second content for output and not the first content, based on the identification that the threshold amount of advertisement-supported broadcast content has been consumed at the computing device.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example environment for delivering application content to a computing device via a broadcast of a unidirectional stream, in accordance with some embodiments of the disclosure;

FIG. 2A shows an example application for outputting application content received via a broadcast of a unidirectional stream, in accordance with some embodiments of the disclosure;

FIG. 2B shows another example application for outputting application content received via a broadcast of a unidirectional stream, in accordance with some embodiments of the disclosure;

FIG. 3 shows another example environment for delivering application content to a computing device via a broadcast of a unidirectional stream, in accordance with some embodiments of the disclosure;

FIG. 4 shows another example environment for delivering application content to a computing device via a broadcast of a unidirectional stream, in accordance with some embodiments of the disclosure;

FIG. 5 shows another example environment for delivering application content to a computing device via a broadcast of a unidirectional stream, in accordance with some embodiments of the disclosure;

FIG. 6 shows another example environment for delivering application content to a computing device via a broadcast of a unidirectional stream, in accordance with some embodiments of the disclosure;

FIG. 7 shows another example environment for delivering application content to a computing device via a broadcast of a unidirectional stream, in accordance with some embodiments of the disclosure;

FIG. 8A shows a flowchart of illustrative steps involved in delivering application content to a computing device via a broadcast of a unidirectional stream, in accordance with some embodiments of the disclosure;

FIG. 8B shows another flowchart of illustrative steps involved in delivering application content to a computing device via a broadcast of a unidirectional stream, in accordance with some embodiments of the disclosure;

FIG. 8C shows another flowchart of illustrative steps involved in delivering application content to a computing device via a broadcast of a unidirectional stream, in accordance with some embodiments of the disclosure;

FIG. 9A shows another flowchart of illustrative steps involved in delivering application content to a computing device via a broadcast of a unidirectional stream, in accordance with some embodiments of the disclosure;

FIG. 9B shows another flowchart of illustrative steps involved in delivering application content to a computing device via a broadcast of a unidirectional stream, in accordance with some embodiments of the disclosure;

FIG. 10 shows another flowchart of illustrative steps involved in delivering application content to a computing device via a broadcast of a unidirectional stream, in accordance with some embodiments of the disclosure;

FIG. 11 shows another flowchart of illustrative steps involved in delivering application content to a computing device via a broadcast of a unidirectional stream, in accordance with some embodiments of the disclosure;

FIG. 12 shows another flowchart of illustrative steps involved in delivering application content to a computing device via a broadcast of a unidirectional stream, in accordance with some embodiments of the disclosure;

FIG. 13 shows a block diagram representing components of a computing device and dataflow therebetween for delivering application content to a computing device via a broadcast of a unidirectional stream, in accordance with some embodiments of the disclosure;

FIG. 14 shows another flowchart of illustrative steps involved in delivering application content to a computing device via a broadcast of a unidirectional stream, in accordance with some embodiments of the disclosure; and

FIG. 15 shows another flowchart of illustrative steps involved in delivering application content to a computing device via a broadcast of a unidirectional stream, in accordance with some embodiments of the disclosure.

### DETAILED DESCRIPTION

A unidirectional stream is any stream for delivering data to multiple receivers, such as smart televisions, that does not comprise a return channel. It includes, for example, a terrestrial or OTA modulated multiplexed television broadcast that is received at a tuner, such as a television tuner, from a transmitter. The modulated multiplexed television broadcast comprises a grouping of program services as interleaved data packets. Other examples include satellite and/or cable modulated multiplexed television broadcasts that are received at a tuner from a respective satellite and/or cable transmitter. This is in contrast to a bidirectional stream, such as an internet protocol stream that comprises a return channel, even though a unidirectional and a bidirectional stream may be transmitted via the same medium. The unidirectional stream may be delivered via a channel, for example a channel with a 6 MHz bandwidth, that is subdivided into virtual subchannels. This may also be described as a multiplex containing a number of channels. In a unidirectional broadcast environment, a receiver is unable to request the retransmission of any data that was missed or received incorrectly. Repeated retransmission of data allows a receiver to deal with the tuning to a channel at an unpredictable time, for instance as a receiver is turned on or a channel is changed at the receiver.

A channel having a 6 MHz bandwidth may, for example, comprise four subchannels, each subchannel corresponding to a different program. A program may have one or more video, audio and/or subtitle streams associated with it. In addition, content associated with an application may be multiplexed into a transport stream, as described herein, so that it can be broadcast via a channel in addition to the programs. A transport stream containing multiplexed video, audio, subtitle (corresponding to one or more programs) and/or application content streams may be broadcast over the channel.

Various embodiments discussed herein use a data and object carousel as a transport mechanism for cyclically broadcasting or repeatedly delivering data in a continuous cycle via a unidirectional stream. Carousels allow data to be pushed from a broadcaster to multiple receivers, such as smart televisions or set-top boxes, by transmitting a data set repeatedly in a standard format. A receiver may tune to the unidirectional stream at any time to receive data, and may reconstitute the received data into a virtual file system. The carousel may therefore be considered as a transport file system or file broadcasting system that enables data files to be transmitted from a broadcaster to multiple receivers or clients simultaneously. The carousel may be defined in a broadcasting specification, such as a digital video broadcasting (DVB) specification, (e.g., the Advanced Television Systems Committee (ATSC) 1.0 standard or the ATSC 3.0 standard). The period of the carousel repeating, the carousel cycle period, determines the maximum time required for a receiver to acquire transmitted data. In some examples, data access time may be reduced, for example for commonly used files, by broadcasting some data more often than others. An individual object carousel may be referred to as a service domain in some specifications. A service domain is a group of related digital storage media command and control (DSM-CC) objects. In broadcast systems, typically there is no difference between an object carousel and a service domain except for the terminology: an object carousel is a service domain, and a service domain is an object carousel. A data and object carousel may also be used in cable networks to deliver software updates and other data to cable set-top boxes and other receivers.

Content associated with an application includes an image, a picture, audio, video, text, a video game and/or any other media content. The content may be a single media item. In other examples, it may be a series (or season) of episodes. Video includes audiovisual content such as movies and/or television programs or portions thereof. Audio includes audio-only content, such as podcasts or portions thereof. Text includes text-only content, such as event descriptions or portions thereof. Although the content associated with an application may comprise video, audio and/or subtitles, it is a separate stream from the video, audio and/or subtitles associated with a subchannel program.

An application is any application that can run on a computing device. Illustratively, an application is an application associated with an OTT content provider, such as Netflix, Amazon Prime Video, Disney+, HBO, and/or Hulu. Typically these applications may receive content and output the received content via an integrated media player.

The disclosed methods and systems may be implemented on one or more devices, such as user devices and/or computing devices. As referred to herein, the device can be any device comprising a processor and memory, for example, a handheld computer, a mobile telephone, a portable video player, a portable music player, a portable gaming machine, a smartphone, a smartwatch, a smart speaker, an augmented reality headset, a mixed reality device, a virtual reality device, a gaming console, vehicle infotainment headend or any other computing equipment, wireless device, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, USB drive, DVD, CD, media cards, register memory, processor caches, random access memory (RAM) and/or a solid-state drive.

The examples and embodiments described herein enable a computing device, such as a smart television, capable of receiving a digital transmission to receive digital data, including application content such as VOD content, via an OTA broadcast channel. In one example, a computing device receives an OTA broadcast channel comprising a plurality of multiplexed digital subchannels within the single broadcast channel. The computing device may receive the single channel comprising the plurality of multiplexed digital subchannels via a single tuner. The digital subchannels may comprise audio, video and/or subtitle program streams, and one or more subchannels for delivering data, such as application content that may be utilized by an application running on the computing device. The OTA broadcast may include an application identifier interleaved with content data, and the received data may be stored in a storage medium at the computing device. The storage medium may be associated with an application identified by the application identifier. A notification associated with the application may be output at the computing device, the application may be launched at the computing device, and the application may output content comprising the aggregated received digital data. The OTA broadcast may meet the ATSC 3.0 standard and may leverage a multi-program transport stream container format.

The order of the applications listed at the computing device may be changed based on the data received via the OTA broadcast, and/or an application may be installed at the computing device based on application data received via the OTA broadcast. In some examples, the received application data may comprise video content, such as short or long form video content, an advertisement and/or application data (such as the data required to install or update an application). When a computing device receives OTA program content that is broadcast on a particular channel, applications associated with that channel may receive data updates to applications associated with that channel via the received program content. For example, a received channel associated with Disney may receive data, including content, associated with a Disney+ application. This content may be, for example, video content that may be previewed or played within the Disney+ application. The received data may comprise installation and application data, which may be used to install the Disney+ application at the computing device if the Disney+ application is not installed. The data may be received when it is made available during a time period. For example, the application data may be repeatedly received during subsequent content viewings across a content title, for example, if the computing device is repeatedly tuned to a particular channel to consume a daily broadcast program, such as a television show during a week period. In other examples, the data may be repeatedly broadcast on a particular channel, or a group of channels (such as CBS channels). Upon receipt of the totality of the required data at the computing device, an installed application may be launched to enable content to be consumed (in the case where the received data is content) via an installed application. In other examples, on receipt of the totality of the required data at the computing device, an application may be installed and/or updated. As the codecs used to encode audio and video in digital channels become more efficient, there will be more bandwidth available in a broadcast channel for delivering additional content.

As application data, or content, is received via a carousel, the data is effectively received at the computing device over a period of time. The received application data may be stored on a storage medium on the computing device and may be assembled as it trickles in. Upon receipt of the totality of a particular application data item, such as VOD content, the data item is checked for completeness (using, for example, a checksum received with the content via the unidirectional broadcast). In some examples, a given channel is force-tuned by a particular application running on the computing device during specified time periods (for example, overnight) for the sole purpose of receiving additional, duplicate and/or new data. For example, at 1:00 AM the Disney+ application may force tune a smart television away from a channel comprising non-Disney subchannels that it is currently tuned to and to a channel comprising a subchannel associated with the Disney+ application, such as an ABC or an ABC-affiliated subchannel. In some examples, a channel may comprise, for example, an ABC subchannel in addition to subchannels from other providers. Following the example, the application may force tune the smart television back to its previously tuned channel at 5:00 AM.

Received application data, or application content such as VOD content, may comprise a plurality of packets. If all of the content packets are not received and saved to storage during an initial carousel broadcast, any missing packets need to be identified in order to save those missing packets to storage during a subsequent carousel broadcast, or broadcasts. One way to do this is to utilize a program clock reference (PCR). Both an MPEG-2 multi-program transport stream (MP2MPTS) and an MPEG-2 single-program transport stream (MP2SPTS) may contain a PCR, which is 33 bits. The PCR is a derived from 27 MHz clock which has a maximum value of:

$$PCR = ( {2}^{33 - 1} ) \times 300 + 299 = 2 , 576 , 980 , 377 , 599$$

PCRs are snapshots of a counter, driven by this program clock, that are inserted into packets within the transport stream (TS) at more or less regular intervals (see, for example, ISO/IEC13818-1, which specifies an interval of 100 ms, and the DVB specification, which recommends an interval of 40 ms). In some examples, the interval can be even smaller. A packet may also comprise a continuity counter, which is a 4-bit length value located at the fourth byte from the beginning of a packet. If the continuity counter value is low enough so the PCR is consistent over the bytes before the continuity counter rollover, any missing content packets may be identified, allowing the missing packets to be saved from a stream on the next broadcast of that stream from the carousel.

An MPEG-2 transport stream (MP2TS) may also comprise supplemental enhancement information (SEI) messaging to identify the application content, such as VOD content, in either an MP2MPTS or an MP2SPTS. A discontinuity indicator, such as a flag, may be set to mark the transition from first application content to second application content, for example, from a first VOD media stream to a second VOD media stream in an MP2MPTS or an MP2SPTS. At the point of receiving the discontinuity indicator, a new content file may be stored at a memory of the computing device, such as a smart television. In some examples, if the first content is incomplete, it may be deleted from the memory of the computing device. In an example, the SEI data may be extracted and stored in a database at the computing device to identify a content provider, application data for an application and a link to the content file that was saved to the computing device memory. An SEI message may comprise data indicating how long application content, such as VOD and/or advertising content, may be valid and/or when it will be outdated. Certain SEI data bits may indicate public information, such as an amber alert, a tornado warning and/or an air raid, that may be directed to a generic public notifications application (for example, as indicated by a carousel application ID) that runs on a computing device, such as on smart tv. In some examples, a user may review the public information at any time, including historical data.

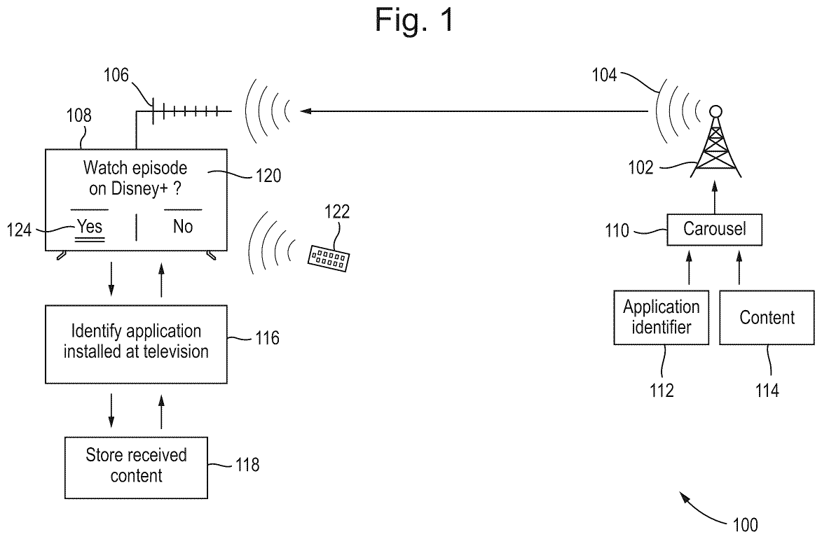

FIG. 1 shows an example environment for delivering application content to a computing device via a broadcast of a unidirectional stream, in accordance with some embodiments of the disclosure. The broadcast of the unidirectional stream may be via a carousel of the unidirectional stream. The environment 100 comprises a transmitter 102 for transmitting 104 a unidirectional stream, such as a channel comprising a plurality of digital subchannels, an antenna 106 for receiving the unidirectional stream, and a computing device 108 comprising a tuner, in this example, a smart television, that receives the unidirectional stream. The transmitter 102 may be an OTA transmitter. In other examples, the transmitter 102 may be a satellite transmitter and/or a cable transmitter. The computing device may be any computing device comprising a tuner including, for example, a PC comprising a tuner card, a smartphone comprising a tuner and/or a tablet device comprising a tuner. A carousel 110 comprising an application identifier 112 and application content 114 is repeatedly transmitted 104 from the transmitter 102. In this example, the application identifier 112 is for a Disney+ application, and the application content 114 is an episode of a television show that can be consumed via the Disney+ application.

The computing device 108 receives the broadcast stream via the antenna 106 and processes the received application identifier 112 to identify 116 an application installed at the computing device 108, and the received content 114 is stored 118 at a memory, such as a solid state memory of the computing device. On receiving the whole content (i.e., in this example, the whole episode), in some examples, via repeated carousel broadcasts, a notification 120 is displayed at the computing device. In this example, the notification 120 comprises “Watch Episode on Disney+?” and two user interface elements “Yes” and “No.” An input associated with the “Yes” user interface element 124 of the notification is received via a remote control 122 of the computing device. In response to receiving the input at the computing device 108, the identified application (in this example, the Disney+ application) is launched, and the received content 114 (in this example, the received episode), is displayed at the computing device 108 via the identified application. In other examples, input may be received via a touchscreen of the computing device, a voice command, a keyboard and/or a mouse.

In some examples, a content identifier may be received via the carousel 110 at the computing device 108, and the content identifier may identify whether each of the unidirectional stream and/or the application content 114 associated with the application should be output at the computing device 108 and/or should be stored at the memory associated with the computing device 108. The computing device 108 may identify, via the content identifier, that a relevant application is installed at the computing device 108, so that the application content 114 may be output at the computing device 108.

In some examples, the application may provide an indication that the received application content 114 that was stored in a memory, such as a non-volatile memory, of the computing device 102 has been generated for output, or played. In response to the indication, the memory holding the content may be released to be used for subsequent content download, for example, the application content 114 may be automatically deleted. In another example, if the received application content 114 has not been generated for output, or played, and new application content is being received, the application may generate a notification that the un-consumed application content 114 will be overwritten, for example, by the new application content that is being received.

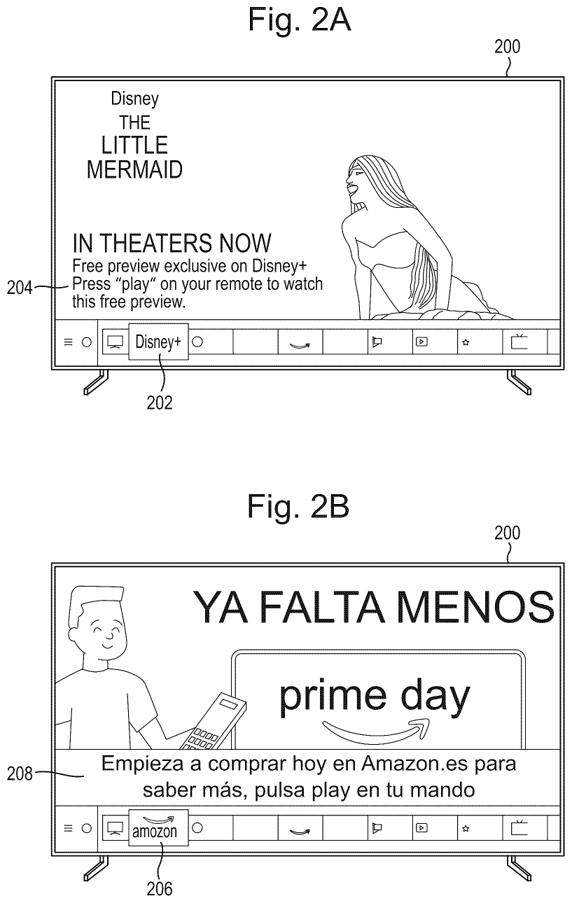

FIG. 2A shows an example application for outputting application content received via a broadcast of a unidirectional stream, in accordance with some embodiments of the disclosure. The broadcast of the unidirectional stream may be via a carousel of the unidirectional stream. FIG. 2A depicts a computing device 200, in this example, a smart television. A display of the computing device 200 displays a user interface of a first installed application 202, and the user interface comprises a notification 204 notifying that content received via a unidirectional stream is available to consume. In an example, the computing device 200 is tuned to an ABC channel, which is owned by Disney, and the computing device 200 receives portions of a trailer for a new theatrical release of “The Little Mermaid.” Upon receipt of the totality of the trailer, a notification 204 is output at the computing device 200 via, for example, an application associated with the trailer, in this example, a Disney+ application. A user interface of the computing device may list a plurality of installed applications, and the associated application may be re-ordered in this list, for example, put to the top of the list, to indicate fresh content. In some examples, the popularity of an application may also be used to decide the order, or the size, of the applications displayed on screen. In other examples, the popularity of an application may be used to position and/or determine a size of an icon associated with each application. The popularity of an application may be based on, for example, a frequency of application usage and/or a duration of application usage. This may be local application usage and/or collated application usage from a plurality of remote users. In addition to, or alternatively to, generating a notification, the application may be automatically launched based on a trigger condition.

A display of the computing device 200 displays a user interface of a first installed application 202, in this example, a Disney+ application. The user interface comprises a notification 204 notifying that content received via a unidirectional stream is available to consume. In this example, the notification 204 comprises “Free preview exclusive on Disney+. Press ‘play’ on your remote to watch this free preview.” On receiving a ‘play’ input via a remote control associated with the computing device 204, the received preview is accessed from a storage associated with the computing device 200, and it is output at the computing device 200.

FIG. 2B shows another example application for outputting application content received via a carousel of a broadcast stream, in accordance with some embodiments of the disclosure. The broadcast of the unidirectional stream may be via a carousel of the unidirectional stream. FIG. 2B depicts the computing device 200, in this example, a smart television. A display of the computing device 200 displays a user interface of a second installed application 206, and the user interface comprises content 208, in this example text content, received via a unidirectional stream. The text content may comprise, for example, an advertisement associated with the second application. In an example, the computing device 200 receives an Amazon advertisement, and an application associated with the received advertisement, in this example, an Amazon application, may be used to navigate through subsequent “pages” of the advertisement.

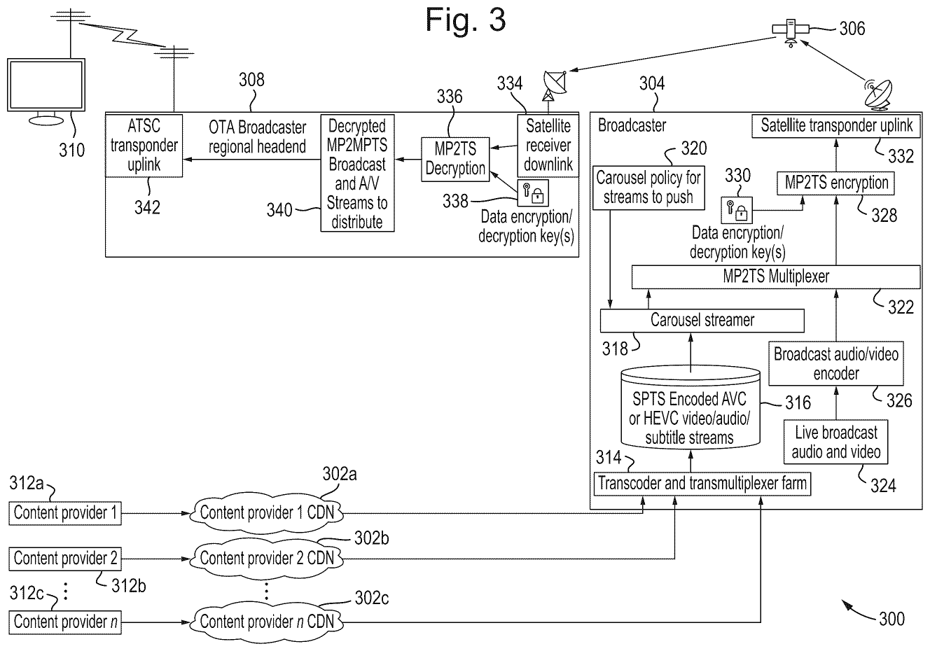

FIG. 3 shows another example environment for delivering application content to a computing device via a broadcast of a unidirectional stream, in accordance with some embodiments of the disclosure. The broadcast of the unidirectional stream may be via a carousel of the unidirectional stream. The environment 300 is an example of an ATSC system leveraging MP2MPTSs to distribute application-related content, such as videos, to computing devices, such as smart televisions with preinstalled applications. In this example, only a single tuner may be needed in the computing device. Application-related content, such as VOD and/or advertisement content, may be distributed in a broadcast channel as multiple MP2SPTSs multiplexed into an MP2MPTS stream. When the multiplexed stream is received at the computing device, a demultiplexer demultiplexes the multiplexed stream to elementary streams. The streams may be identified by a packet identifier (PID) as defined by the MP2TS specification. The PIDs may contain data to identify whether the received content is to be rendered or is to be stored locally at a memory of the computing device. In this example, the broadcaster distributes the MP2MPTS over a satellite feed and a local affiliate broadcasts this MP2MPTS, which is received by the computing device that, in this example, is a smart television.

The environment 300 comprises a plurality of content delivery networks (CDNs) 302a-302c, a broadcaster 304, a satellite transmitter 306, an OTA broadcaster regional headend 308 and a computing device 310, in this example a smart television. A plurality of content providers 312a-312c transmit application content, such as VOD content, to the CDNs 302a-302c. The application content is transmitted from the CDNs 302a-302c to the broadcaster 304.

At the broadcaster 304, a transcoder and transmultiplexer farm 314 receives the application content from the CDNs 302a-302c, where the application content is transcoded and multiplexed. The multiplexed content is transmitted to an encoder 316, where a single program transport stream (SPTS) is encoded with advanced video coding (AVC) or high efficiency video coding (HEVC) video, audio and/or subtitle streams. The encoded application content is transmitted to a carousel streamer 318, where it is added to a carousel as defined by a carousel policy 320. The carousel is transmitted to an MP2TS multiplexer 322. At the broadcaster 304, one or more audio and video streams 324 of one or more programs, such as live broadcast programs, are received, and they are transmitted to the broadcast audio/video encoder 326, where they are encoded. The encoded audio and video streams are transmitted to the MP2TS multiplexer 322, where they are multiplexed with the carousel comprising the application content. The multiplexed MP2TS is transmitted to an MP2TS encryptor 328, which receives encryption keys 330 and encrypts the multiplexed MP2TS. The encrypted MP2TS is transmitted to a satellite transponder uplink 322, where it is transmitted from the broadcaster 304 and is received by the satellite 306. The encrypted MP2TS is transmitted from the satellite 306 and is received at the OTA broadcaster regional headend 308.

At the OTA broadcaster regional headend 308, a satellite receiver downlink 334 receives the encrypted MP2TS from the satellite and decrypts 336 the stream with data decryption keys 338. The decrypted MP2MPTS 340 comprises the live broadcast programs and the application data are transmitted to an ATSC transponder uplink 342 where they are broadcast. The broadcast is received at a tuner of the computing device 310, where it is demultiplexed and the application content is stored to a memory of the computing device 310.

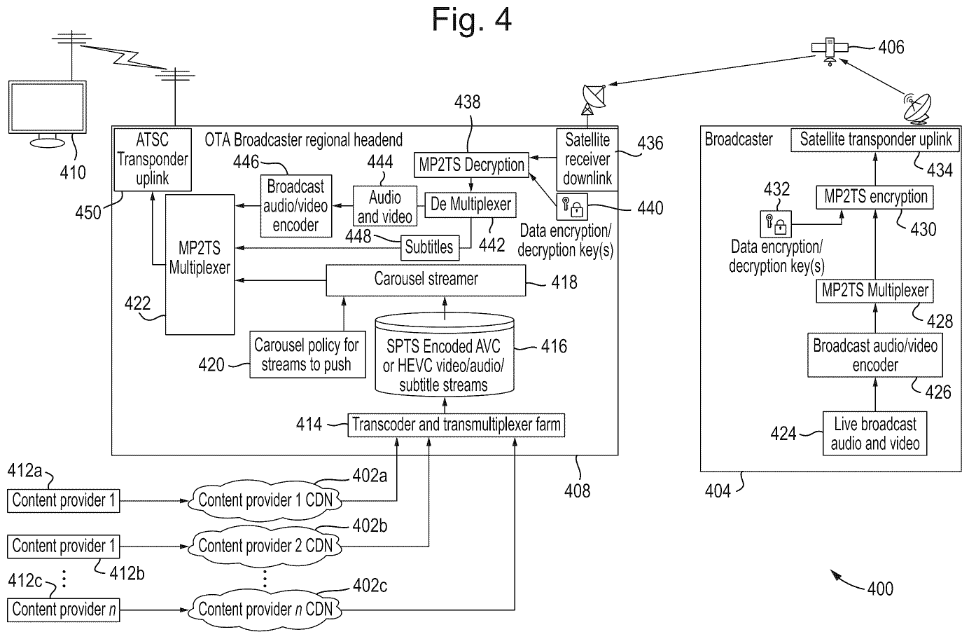

FIG. 4 shows another example environment for delivering application content to a computing device via a broadcast of a unidirectional stream, in accordance with some embodiments of the disclosure. The broadcast of the unidirectional stream may be via a carousel of the unidirectional stream. The environment 400 comprises an architecture in which an OTA broadcaster regional headend receives application content to distribute in a manner similar to that shown in the environment 300. In this example, all the distribution is handled by the OTA broadcaster.

The environment 400 comprises a plurality of CDNs 402a-402c, a broadcaster 404, a satellite transmitter 406, an OTA broadcaster regional headend 408 and a computing device 410, in this example a smart television. A plurality of content providers 412a-412c transmit application content, such as VOD content, to the CDNs 402a-402c. The application content is transmitted from the CDNs 402a-402c to the OTA broadcaster regional headend 408.

At the OTA broadcaster regional headend 408, a transcoder and transmultiplexer farm 414 receives the application content from the CDNs 402a-402c, where the application content is transcoded and multiplexed. The multiplexed content is transmitted to an encoder 416, where an SPTS is encoded with AVC or HEVC video, audio and/or subtitle streams. The encoded application content is transmitted to a carousel streamer 418, where it is added to a carousel as defined by a carousel policy 420. The carousel is transmitted to an MP2TS multiplexer 422.

At the broadcaster 404, one or more audio and video streams 424 of one or more programs, such as live broadcast programs, are received, and they are transmitted to the broadcast audio/video encoder 426, where they are encoded. The encoded audio and video streams are transmitted to the MP2TS multiplexer 428, where they are multiplexed. The multiplexed MP2TS is transmitted to an MP2TS encryptor 430, which receives encryption keys 432 and encrypts the multiplexed MP2TS. The encrypted MP2TS is transmitted to a satellite transponder uplink 434, where it is transmitted from the broadcaster 404 and is received by the satellite 406. The encrypted MP2TS is transmitted from the satellite 406 and is received at the OTA broadcaster regional headend 408.

At the OTA broadcaster regional headend 408, a satellite receiver downlink 436 receives the encrypted MP2TS from the satellite and decrypts 438 the stream with data decryption keys 440. The decrypted MP2TS is demultiplexed at a demultiplexer 442, and demultiplexed audio and video streams 444 are transmitted to an encoder 446, where they are encoded and are subsequently transmitted to the MP2TS multiplexer 422. Any demultiplexed subtitle stream 448 are transmitted from the demultiplexer 442 to the MP2TS multiplexer 422. At the MP2TS multiplexer 422, the audio, video and any subtitle streams are multiplexed with the carousel comprising the application content into an MP2TS. The MP2TS is transmitted to an ATSC transponder uplink 450 where it is broadcast. The broadcast is received at a tuner of the computing device 410, where it is demultiplexed and the application content is stored to a memory of the computing device 410.

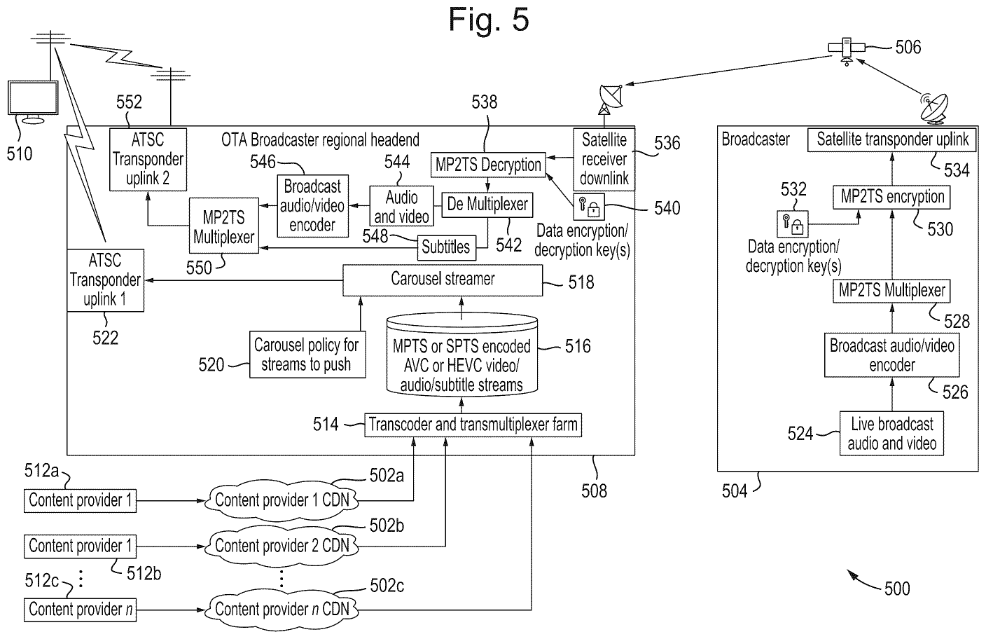

FIG. 5 shows another example environment for delivering application content to a computing device via a broadcast of a unidirectional stream, in accordance with some embodiments of the disclosure. The broadcast of the unidirectional stream may be via a carousel of the unidirectional stream. The environment 500 comprises an architecture in which a broadcast carousel is received by a separate tuner of a computing device, such as a smart television. In this example, the computing device comprises at least two separate tuners. One tuner receives the broadcast live content (i.e., live audio and/or visual streams), and the second tuner receives the broadcast application content, such as VOD content.

The environment 500 comprises a plurality of CDNs 502a-502c, a broadcaster 504, a satellite transmitter 506, an OTA broadcaster regional headend 508 and a computing device 510, in this example a smart television. A plurality of content providers 512a-512c transmit application content, such as VOD content, to the CDNs 502a-502c. The application content is transmitted from the CDNs 502a-502c to the OTA broadcaster regional headend 508.

At the OTA broadcaster regional headend 408, a transcoder and transmultiplexer farm 514 receives the application content from the CDNs 502a-502c, where the application content is transcoded and multiplexed. The multiplexed content is transmitted to an encoder 516, where an SPTS is encoded with AVC or HEVC video, audio and/or subtitle streams. The encoded application content is transmitted to a carousel streamer 518, where it is added to a carousel as defined by a carousel policy 520. The carousel is transmitted to a first ATSC transponder uplink 522, which broadcasts the carousel. The broadcast is received at a first tuner of the computing device 510, where it is demultiplexed, and the application content is stored to a memory of the computing device 510.

At the broadcaster 504, one or more audio and video streams 524 of one or more programs, such as live broadcast programs, are received, and they are transmitted to the broadcast audio/video encoder 526, where they are encoded. The encoded audio and video streams are transmitted to the MP2TS multiplexer 528, where they are multiplexed. The multiplexed MP2TS is transmitted to an MP2TS encryptor 530, which receives encryption keys 532 and encrypts the multiplexed MP2TS. The encrypted MP2TS is transmitted to a satellite transponder uplink 534, where it is transmitted from the broadcaster 504 and is received by the satellite 506. The encrypted MP2TS is transmitted from the satellite 506 and is received at the OTA broadcaster regional headend 508.

At the OTA broadcaster regional headend 508, a satellite receiver downlink 536 receives the encrypted MP2TS from the satellite and decrypts 538 the stream with data decryption keys 540. The decrypted MP2TS is demultiplexed at a demultiplexer 542, and demultiplexed audio and video streams 544 are transmitted to a transcoder 546, where they are encoded and are subsequently transmitted to an MP2TS multiplexer 550. Any demultiplexed subtitle stream 548 are transmitted from the demultiplexer 542 to the MP2TS multiplexer 550. At the MP2TS multiplexer 550, the audio, video and any subtitle streams are multiplexed into an MP2TS. The MP2TS is transmitted to an ATSC transponder uplink 552 where it is broadcast. The broadcast is received at a tuner of the computing device 510, where it is demultiplexed, and the audio, video and any subtitles may be output at the computing device 510.

FIG. 5 is an example of an ATSC system leveraging MP2MPTSs to distribute application-related content, such as VOD, to computing devices, such as smart televisions with preinstalled applications. In this example, two tuners are utilized so that a computing device can receive a first channel comprising a program for output at the computing device and a second channel comprising application content, such as VOD content. This type of architecture may also support a computing device comprising single tuner; however, with a single tuner, the tuner is force-tuned to a broadcast channel frequency for receiving application content, such as VOD content, when the tuner is not being used for receiving a broadcast program for output, such as live television content. The application content may be broadcast on a second transponder dedicated for content distribution, and a dedicated tuner may be utilized to receive that broadcast content. This dedicated tuner may be a secondary tuner, or the primary tuner when not in use for receiving an OTA program for output, such as live television content. When a tuner at the computing device receives the broadcast stream, a demultiplexer demultiplexes the elementary streams. The streams are identified by the packet identifier or PID as defined by the MP2TS specification. In this example, the broadcaster may not distribute the streams, as it is dependent on an affiliate. This may eliminate the need to mux the SPTS corresponding to application content, such as VOD content, from being muxed into a broadcast transport stream. A VOD stream from a content provider may be retrieved, transcoded, and multiplexed into an MP2SPTS or an MP2MPTS. Since these are pre-multiplexed, a carousel streamer may stream directly to a transponder without any multiplexing. In this example, continuity counters and PCRs may be preserved from the initial MP2TS multiplexing when it is stored for the carousel to eventually stream directly to the transponder. In this example, the discontinuity indicator may be at the start of the pre-multiplexed SPTS or multi program transport stream (MPTS). SEI data containing metadata for the application content may be inserted immediately after the discontinuity indicator when the pre-multiplexing takes place.

In some examples, MPEG-7 metadata and/or key-length-value (KLV) metadata may be multiplexed into each of the multi-program streams. These types of metadata may be leveraged to provide further metadata related to the content to be stored over SEI messages. This metadata may be multiplexed into the MP2MPTS streams for each program, for example, where the application content is not embedded into a broadcast stream for viewing.

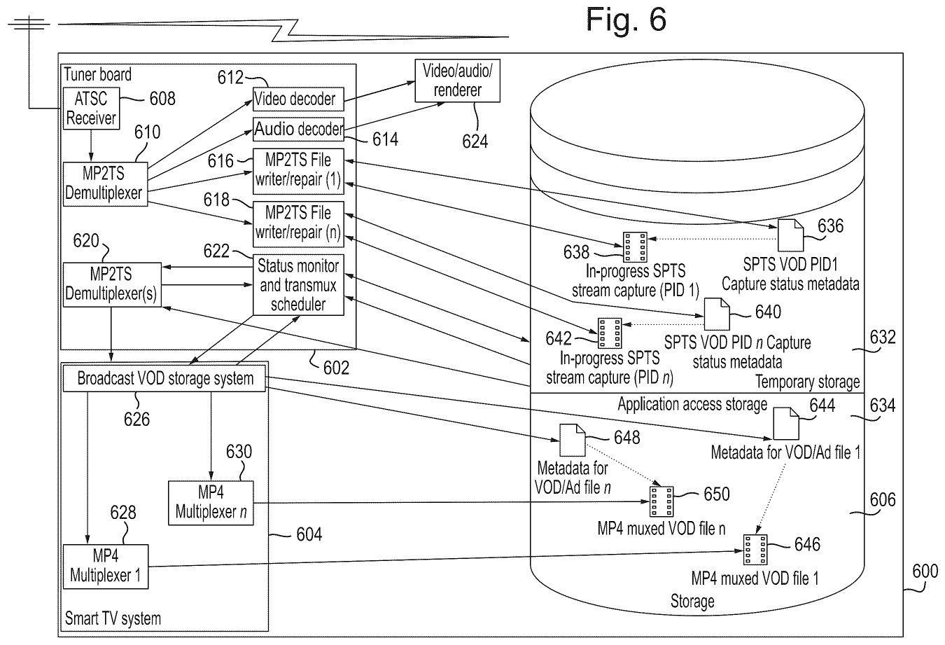

FIG. 6 shows another example environment for delivering application content to a computing device via a broadcast of a unidirectional stream, in accordance with some embodiments of the disclosure. The broadcast of the unidirectional stream may be via a carousel of the unidirectional stream. The environment 600 comprises a computing device system architecture for receiving application content, such as VOD content, in an MP2MPTS with programs, such as live broadcast content.

The environment 600 comprises a tuner board 602; a computing device system 604, in this example, a smart television system; and storage 606. A broadcast signal comprising an MP2TS is received via an antenna of the computing device and is transmitted to an ATSC receiver 608 of the tuner board 602. The received MP2TS is transmitted from the ATSC receiver 608 to a first MP2TS demultiplexer 610, where it is demultiplexed into elementary audio, video and application content streams. The video stream, or streams, is transmitted to a video decoder 612; the audio stream, or streams, is transmitted to an audio decoder 614; and the application content stream, or streams, is transmitted to an MP2TS file writer/repairer 616. In the case of multiple application content streams, one or more additional MP2TS file writer/repairers 618 may be utilized. The tuner board 602 also comprises one or more additional MP2TS demultiplexers 620 and a status monitor and transmux scheduler 622. The decoded video and audio are transmitted from the respective decoders 612, 614 to a video and audio renderer 624, where the video and audio streams of a program are rendered for output (e.g., a live broadcast stream for user viewing for a channel). The status monitor and transmux scheduler reads and writes application content data to the storage 606, and transmits streams to an additional MP2TS demultiplexer 620, where they are demultiplexed. The demultiplexed streams are transmitted to the computing device system 604.

At the computing device system 604, a broadcast application content storage system 626, in this example a broadcast VOD storage system, receives demultiplexed streams from the additional MP2TS 620 demultiplexer, and communicates with the status monitor and transmux scheduler 622. The broadcast application content storage system 626 transmits demultiplexed streams to a first, and optionally one or more additional MP4 multiplexers 628, 630, where the demultiplexed streams are multiplexed to an MP4 container format.

The storage 606 comprises a temporary storage 632 and an application access storage 634. In the temporary storage 632, the MP2TS file writer/repairer 616 writes and repairs SPTS application content capture status metadata 636, in this example, VOD content capture status metadata, indicated by a PID of one. The MP2TS file writer/repairer 616 also writes and repairs an associated in-progress SPTS stream capture 638, also indicated by a PID of one in this example. The one or more additional MP2TS file writer/repairers 618 write and repair additional SPTS application content capture status metadata 640 and in-progress SPTS stream captures 642, which are indicated by their respective PIDs. In the application access storage 634, the broadcast application content storage system 626 writes metadata 644 for a first application content file, for example, metadata associated with VOD and/or advertisement content. A first MP4 muxed application content file 646, for example a VOD and/or advertisement content file, is written to storage from the first MP4 multiplexer 628. The metadata file 644 is associated with the first MP4 muxed application content file 646. One or more additional metadata 648 for a first application content file and associated MP4 muxed application content files 650 are written to storage from the broadcast content application system 626 and one or more additional MP4 multiplexers 630.

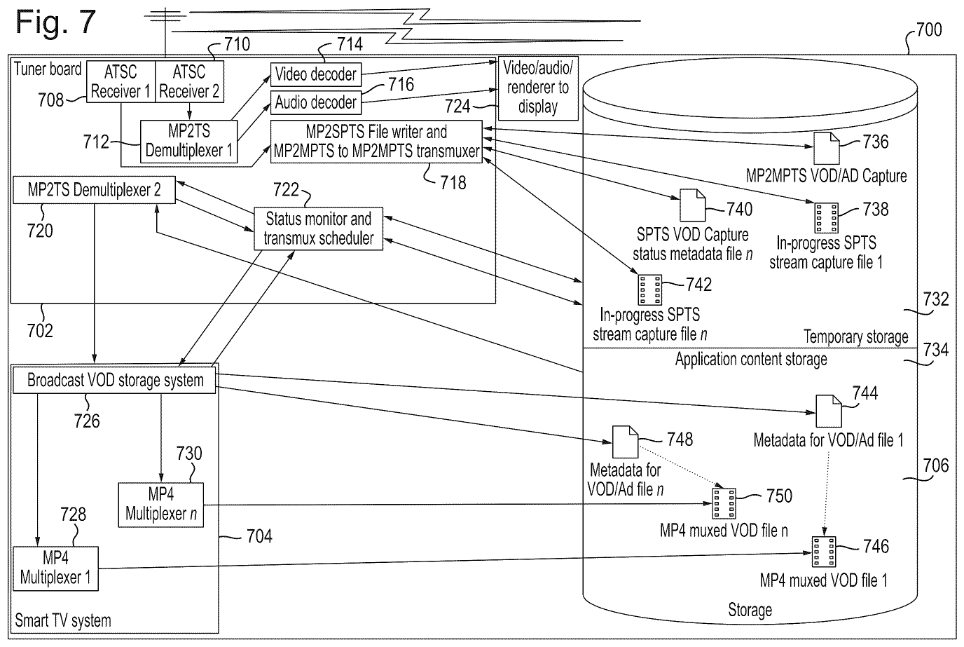

FIG. 7 shows another example environment for delivering application content to a computing device via a broadcast of a unidirectional stream, in accordance with some embodiments of the disclosure. The broadcast of the unidirectional stream may be via a carousel of the unidirectional stream. The environment 700 comprises a system architecture for a computing device, such as a smart TV, for received application content, such as VOD content, in an MP2SPTS and/or a pre-encoded MP2MPTS on a separate tuner/frequency.

The environment 700 comprises a tuner board 702; a computing device system 704, in this example, a smart television system; and storage 706. Two broadcast signals are received via an antenna of the computing device and are transmitted to a first ATSC receiver 708 and a second ATSC tuner 710 of the tuner board 702. A received MP2TS is transmitted from the first ATSC receiver 708 to a first MP2TS demultiplexer 712, where it is demultiplexed into elementary audio, video and application content streams. The video stream, or streams, is transmitted to a video decoder 714; the audio stream, or streams, is transmitted to an audio decoder 716. An application content stream, or streams, is transmitted to an MP2SPTS file writer and MP2MPTS to MP2SPTS transmuxer 718. The tuner board 702 also comprises a second MP2TS demultiplexer 720 and a status monitor and transmux scheduler 722. The decoded video and audio are transmitted from the respective decoders 714, 716 to a video and audio renderer 724, where the video and audio streams of a program are rendered for output. The status monitor and transmux scheduler reads and writes application content data to the storage 706, and transmits streams to the second MP2TS demultiplexer 720, where they are demultiplexed. The demultiplexed streams are transmitted to the computing device system 704.

At the computing device system 704, a broadcast application content storage system 726, in this example a broadcast VOD storage system, receives demultiplexed streams from the second MP2TS 720 demultiplexer, and communicates with the status monitor and transmux scheduler 722. The broadcast application content storage system 726 transmits demultiplexed steams to a first, and optionally one or more additional MP4 multiplexers 728, 730, where the demultiplexed streams are multiplexed to an MP4 container format.

The storage 706 comprises a temporary storage 732 and an application content storage 734. In the temporary storage 732, the MP2SPTS file writer and MP2MPTS to MP2SPTS transmuxer 718 writes and repairs SPTS application content capture status metadata 736, in this example, VOD content capture status metadata, indicated by a PID of one. The MP2SPTS file writer and MP2MPTS to MP2SPTS transmuxer 718 also writes and repairs an associated in progress SPTS stream capture 738, also indicated by a PID of one in this example. The MP2SPTS file writer and MP2MPTS to MP2SPTS transmuxer 718 also writes and repairs additional SPTS application content capture status metadata 740 and in-progress SPTS stream captures 742, which are indicated by their respective PIDs. The capture status metadata 740 may comprise metadata associated with the content file received from SEI messages and/or MPEG-7 and/or KLV metadata. There may also be a recording of the packets captured. The SEI, MPEG-7 and/or KLV metadata may be repeated during the transmission (i.e., via the carousel) of content, and it is unlikely that the metadata will need repairing as a result of a later carousel transmission; however, the captured packets may continue to be updated. These captured packets enable, for example, the repair functionality to repair missing packets when they arrive in a following carousel transmission.

In the application content storage 734, the broadcast application content storage system 726 writes metadata 744 for a first application content file, for example, metadata associated with VOD and/or advertisement content. A first MP4 muxed application content file 746, for example a VOD and/or advertisement content file, is written to storage from the first MP4 multiplexer 728. The metadata file 744 is associated with the first MP4 muxed application content file 746. One or more additional metadata 748 for a first application content file and associated MP4 muxed application content files 750 are written to storage from the broadcast content application system 726 and one or more additional MP4 multiplexers 730.

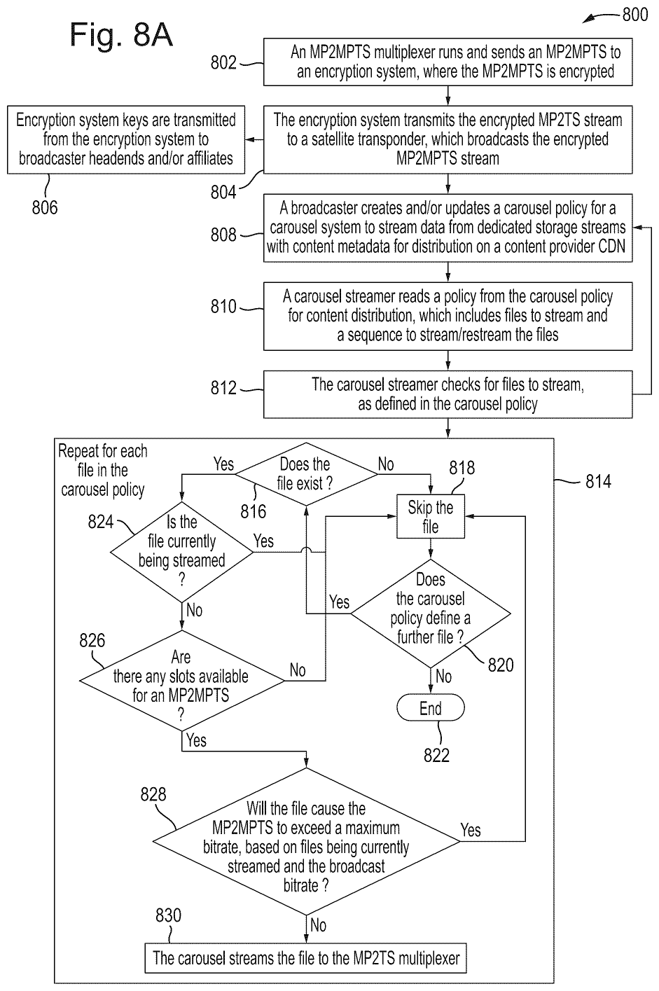

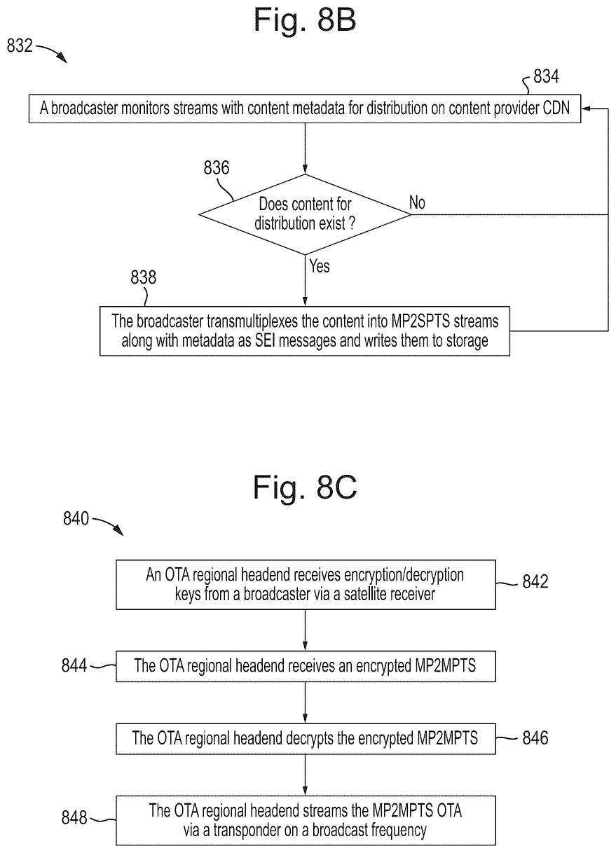

FIGS. 8A-8C show flowcharts of illustrative steps involved in delivering application content to a computing device via a carousel of a unidirectional stream, in accordance with some embodiments of the disclosure. Processes 800, 832 and 840 enable broadcaster distribution methods, such as a broadcaster receiving and distributing application content, such as VOD and/or advertisement content, to be distributed one or more local headends and/or affiliates for distribution OTA for locally stored computing device, such as smart television, content. The processes 800, 832 and 840 may be implemented, in whole or in part, on any of the aforementioned computing devices. In addition, one or more actions of the processes 800, 832 and 840 may be incorporated into or combined with one or more actions of any other processes or embodiments described herein.

FIG. 8A comprises process 800, where, at 802, an MP2MPTS multiplexer runs and sends an MP2MPTS to an encryption system, where the MP2MPTS is encrypted. At 804, the encryption system transmits the encrypted MP2TS stream to a satellite transponder, which broadcasts the encrypted MP2MPTS stream. At 806, encryption system keys are transmitted from the encryption system to broadcaster headends and/or affiliates. At 808, a broadcaster creates and/or updates a carousel policy for a carousel system to stream data from dedicated storage streams, such as VOD and/or advertisement streams, with content metadata for distribution on a content provider CDN. At 810, a carousel streamer reads a policy from the carousel policy for content distribution, which includes files to stream and a sequence to stream and/or restream the files. At 812, the carousel streamer checks for files to stream, as defined in the carousel policy, and the process loops back to step 808 as appropriate. The process proceeds from step 812 to step 814, where steps 816-830 are repeated for each file in the carousel policy.

At 816, it is determined whether the file exists. If, at step 816, it is determined that the file does not exist, then the process proceeds to step 818, where the file is skipped. The process proceeds to step 820, where it is determined whether the carousel policy defines a further file. If a further file is defined, the process loops back to step 816. If a further file is not defined, the process proceeds to step 822, where the process ends.

At 816, if it is determined that the file exists, the process proceeds to step 824, where it is determined whether the file is currently being streamed. If, at step 816, it is determined that the file is currently being streamed, the process proceeds to step 818, as previously described. If the file is not currently being streamed, the process proceeds to step 826, where it is determined whether there are any slots available for an MP2MPTS. If, at 826, it is determined that there are no slots available, the process proceeds to step 818, as previously described. If, at step 826, there are slots available, the process proceeds to step 828, where it is determined whether the file will cause the MP2MPTS to exceed a maximum bitrate, based on files currently being streamed and the broadcast bitrate. If, at step 828, it is determined that the file will cause the maximum bitrate to be exceeded, the process proceeds to step 818, as previously described. If, at step 828, it is determined that the file will not cause the maximum bitrate to be exceeded, the process proceeds to step 830, where the carousel streams the file to the MP2TS multiplexer, for example, on a user datagram protocol (UDP) network address for the MP2MPTS multiplexer.

FIG. 8B comprises process 832, where, at 834, a broadcaster monitors streams with application content metadata for distribution on content provider CDN. At 836, it is determined whether application content for distribution exists. If, at step 836, it is determined that application content for distribution does not exist, the process loops back to step 834. If, at step 836, it is determined that application content for distribution exists, the process proceeds to step 838, where the broadcaster transmultiplexes the application content, such as VOD and/or advertising content, into MP2SPTS streams along with metadata as SEI messages and writes them to storage.

FIG. 8C comprises process 840, where, at 842, an OTA regional headend receives encryption and/or decryption keys from a broadcaster via a satellite receiver. At 844, the OTA regional headend receives an encrypted MP2MPTS. At 846, the OTA regional headend decrypts the encrypted MP2MPTS, and at 848, the OTA regional headend streams the MP2MPTS OTA via a transponder on a broadcast frequency.

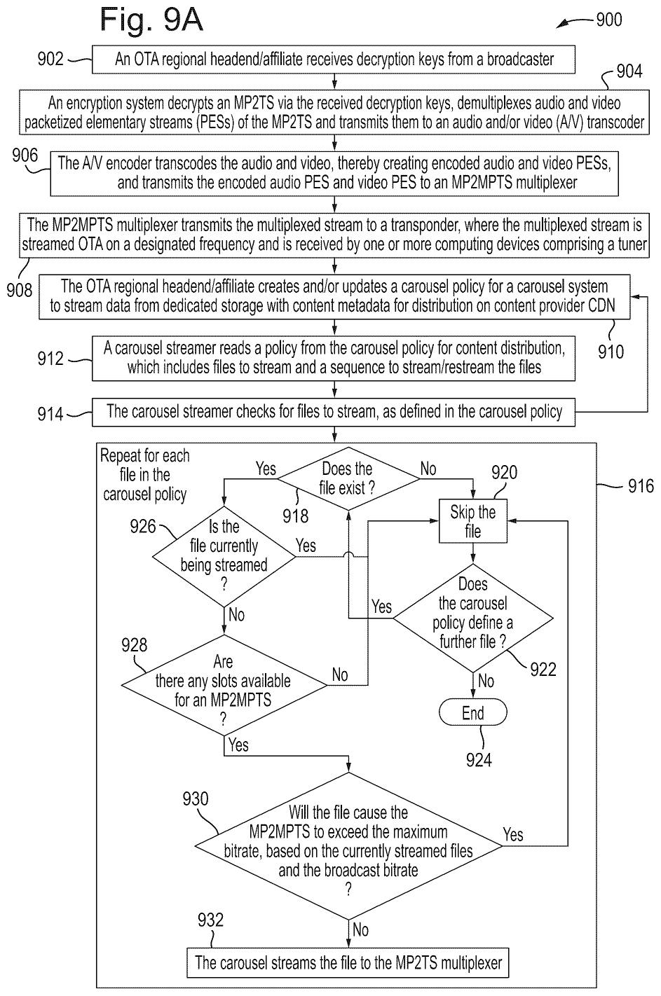

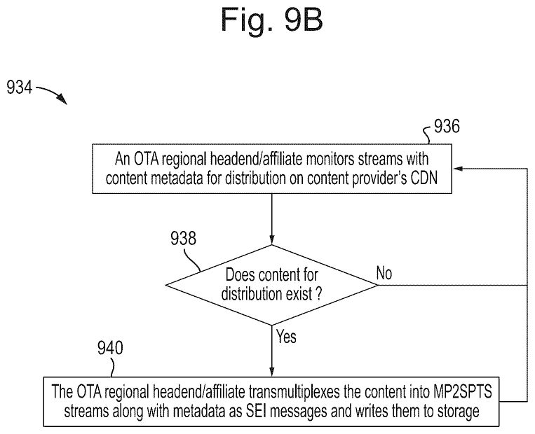

FIGS. 9A and 9B show flowcharts of illustrative steps involved in delivering application content to a computing device via a carousel of a unidirectional stream, in accordance with some embodiments of the disclosure. Processes 900 and 934 enable regional headend and/or affiliate distribution methods, such as a broadcast regional headend receiving application content, such as VOD and/or advertisement content, and transmitting it OTA to one or more computing devices comprising a tuner, such as one or more smart televisions. The processes 900 and 934 may be implemented, in whole or in part, on any of the aforementioned computing devices. In addition, one or more actions of the processes 900 and 934 may be incorporated into or combined with one or more actions of any other processes or embodiments described herein.

FIG. 9A comprises process 900, where, at 902, an OTA regional headend and/or affiliate receives decryption keys from a broadcaster. At 904, an encryption system decrypts an MP2TS via the received decryption keys, demultiplexes audio and video packetized elementary streams (PESs) of the MP2TS and sends them to an audio and/or video (A/V) transcoder. At 906, the A/V encoder transcodes the audio and video, thereby creating encoded audio and video PESs, and transmits the encoded audio PES and video PES to an MP2MPTS multiplexer. At 908, the MP2MPTS multiplexer transmits the multiplexed stream to a transponder, where the multiplexed stream is streamed OTA on a designated frequency and is received by one or more computing devices comprising a tuner, such as one or more smart televisions. At 910, the OTA regional headend and/or affiliate creates and/or updates a carousel policy for a carousel system to stream data from dedicated storage with application content metadata for distribution on content provider CDN. At 912, a carousel streamer reads a policy from the carousel policy for application content distribution, which includes files to stream and a sequence to stream/restream the files, and at 914, the carousel streamer checks for files to stream, as defined in the carousel policy. The process proceeds from step 914 to step 916, where steps 918-932 are repeated for each file in the carousel policy.

At 918, it is determined whether the file exists. If, at step 918, it is determined that the file does not exist, then the process proceeds to step 920, where the file is skipped. The process proceeds to step 922, where it is determined whether the carousel policy defines a further file. If a further file is defined, the process loops back to step 918. If a further file is not defined, the process proceeds to step 924, where the process ends.

At 918, if it is determined that the file exists, the process proceeds to step 926, where it is determined whether the file is currently being streamed. If, at step 926, it is determined that the file is currently being streamed, the process proceeds to step 920, as previously described. If the file is not currently being streamed, the process proceeds to step 928, where it is determined whether there are any slots available for an MP2MPTS. If, at 928, it is determined that there are no slots available, the process proceeds to step 920, as previously described. If, at step 928, there are slots available, the process proceeds to step 930, where it is determined whether the file will cause the MP2MPTS to exceed a maximum bitrate, based on files currently being streamed and the broadcast bitrate. If, at step 930, it is determined that the file will cause the maximum bitrate to be exceeded, the process proceeds to step 920, as previously described. If, at step 930, it is determined that the file will not cause the maximum bitrate to be exceeded, the process proceeds to step 932, where the carousel streams the file to the MP2TS multiplexer, for example, on a UDP network address for the MP2MPTS multiplexer.

FIG. 9B comprises process 934, where, at 936, an OTA regional headend and/or affiliate monitors streams with application content metadata for distribution on content provider's CDN. At 938, it is determined whether application content for distribution exists. If, at step 938, it is determined that application content for distribution does not exist, the process loops back to step 936. If, at step 938, it is determined that application content for distribution exists, the process proceeds to step 940, where the OTA regional headend and/or affiliate transmultiplexes the application content, such as VOD and/or advertising content, into MP2SPTS streams along with metadata as SEI messages and writes them to storage.

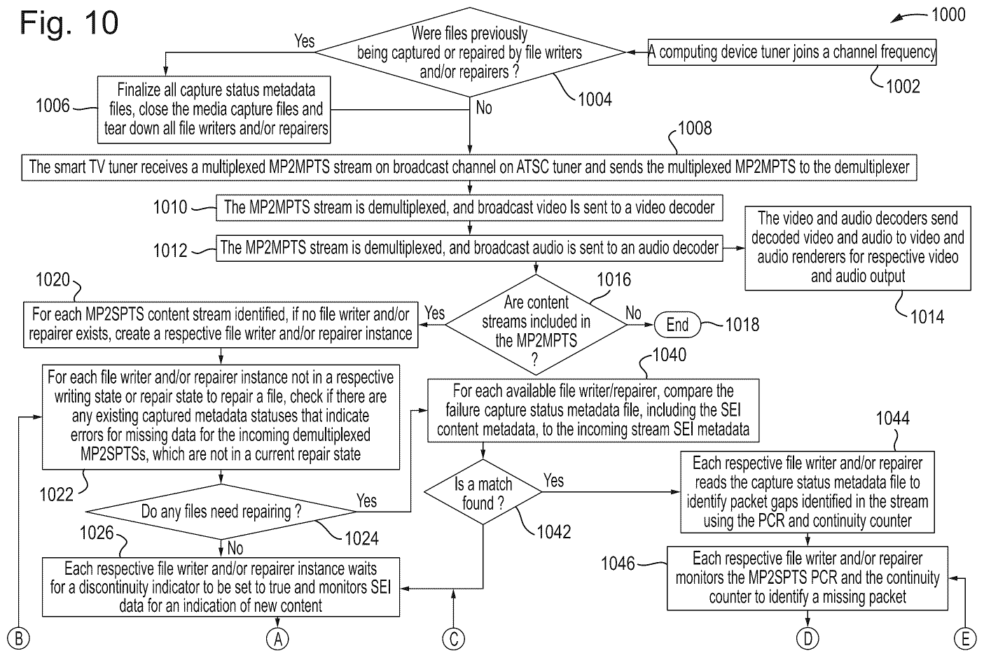

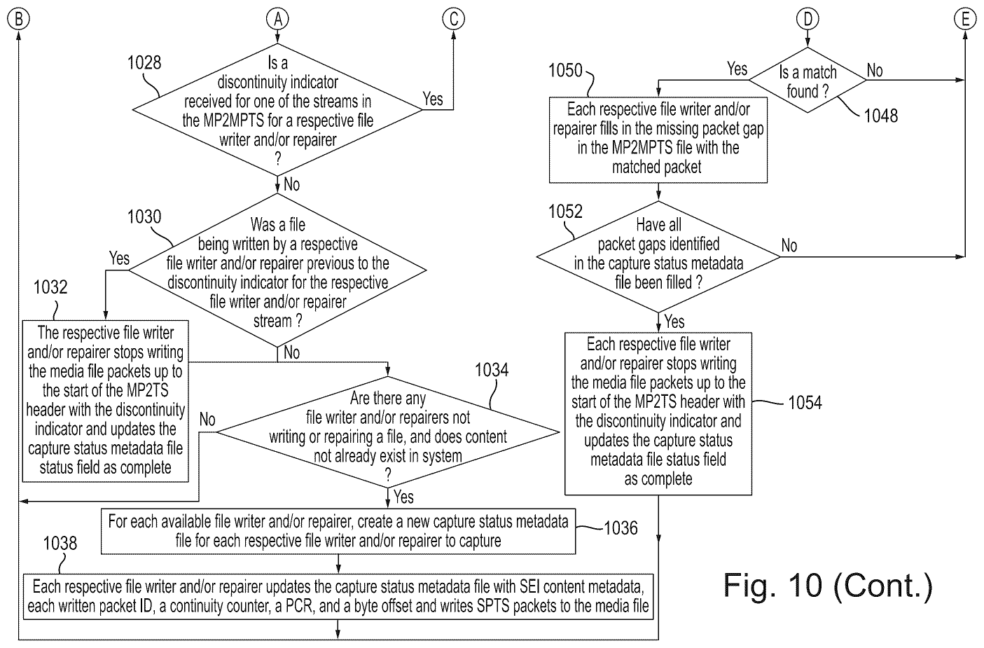

FIG. 10 shows another flowchart of illustrative steps involved in delivering application content to a computing device via a broadcast of a unidirectional stream, in accordance with some embodiments of the disclosure. The broadcast of the unidirectional stream may be via a carousel of the unidirectional stream. Process 1000 enables a single tuner computing device, such as a smart television, to receive an MP2MPTS stream with application content, such as VOD and/or advertisement content, and to make the content available through one or more preinstalled apps on the computing device. Process 1000 may be implemented, in whole or in part, on any of the aforementioned computing devices. In addition, one or more actions of the process 1000 may be incorporated into or combined with one or more actions of any other processes or embodiments described herein.

At 1002, a computing device tuner, such as a smart television tuner, joins a channel frequency. At 1004, it is determined whether files were previously being captured or repaired by file writers and/or repairers. If, at step 1004, it is determined that the files were being captured and/or repaired, then the process proceeds to step 1006, where all capture status metadata files are finalized, the media capture files are closed and a teardown of all file writers and/or repairers occurs. The process then proceeds to step 1008. If, at step 1004, it is determined that the files were not being captured and/or repaired, then the process proceeds to step 1008, where the smart TV tuner receives a multiplexed MP2MPTS stream on broadcast channel (or frequency) on an ATSC tuner and sends the multiplexed MP2MPTS to the demultiplexer. At step 1010, the MP2MPTS stream is demultiplexed, and broadcast video is sent to a video decoder, and at step 1012, the MP2MPTS stream is demultiplexed, and broadcast audio is sent to an audio decoder. From step 1012, at step 1014, the video and audio decoders send decoded video and audio to video and audio renderers for respective video and audio output. Also, from step 1012, it is determined, at step 1016, if any application content streams, such as VOD and/or advertising content streams, are included in the MP2MPTS. If it is determined, at step 1016, that the MP2MPTS does not contain any application content streams, then the process proceeds to step 1018, where the process ends.

If, at step 1016, it is determined that the MP2MPTS does contain application content streams, then the process proceeds to step 1020, where, for each MP2SPTS application content stream identified, if no file writer and/or repairer exists, a respective file writer and/or repairer instance is created. At 1022, for each file writer and/or repairer instance not in a respective writing state or repair state to repair a file, it is checked if there are any existing captured metadata statuses that indicate errors for missing data for the incoming demultiplexed MP2SPTSs, which are not in a current repair state. At step 1024, it is determined if any files need repairing.

If, at step 1024, it is determined that no files need repairing, then the process proceeds to step 1026. At step 1026, each respective file writer and/or repairer instance waits for a discontinuity indicator to be set to true and monitors SEI data for an indication of new application content. At step 1028, it is determined whether a discontinuity indicator has been received for one of the streams in the MP2MPTS for a respective file writer and/or repairer. If, at step 1028, it is determined that a discontinuity indicator has not been received, then the process proceeds to step 1030. If, as step 1028, it is determined that a discontinuity indicator has been received, then the process proceeds back to step 1026.

At step 1030, it is determined whether a file was being written by a respective file writer and/or repairer before to the discontinuity indicator for the respective file writer and/or repairer stream. If, at step 1030, it is determined that a file was being written, then the process proceeds to step 1032, where the respective file writer and/or repairer stops writing the media file packets up to the start of the MP2TS header with the discontinuity indicator and updates the capture status metadata file status field as complete. The process then proceeds to step 1034. If, at step 1030, it is determined that a file is not being written, then the process proceeds to step 1034, where it is determined whether there are any file writer and/or repairers that are not writing and/or repairing a file, and whether application content does not already exist in system. If, at step 1034, it is determined that this is not the case, then the process loops back to step 1022. If, at step 1034, it is determined that this is the case, then the process proceeds to step 1036, where, for each available file writer and/or repairer, a new capture status metadata file is created for each respective file writer and/or repairer to capture. At 1038, each respective file writer and/or repairer updates the capture status metadata file with SEI application content metadata, each written packet ID, a continuity counter, a PCR, and a byte offset and writes SPTS packets to the media file, and the process loops back to step 1022.

If, at step 1024, it is determined that any files need repairing, then the process proceeds to step 1040. At step 1040, for each available file writer and/or repairer, failure capture status metadata file, including the SEI application content metadata, is compared to the incoming SEI metadata from the incoming stream. At 1042, it is determined whether a match is found. If, at step 1042, a match is not found, then the process proceeds to step 1026. At 1042, if a match is found, then the process proceeds to step 1044, where each respective file writer and/or repairer reads the capture status metadata file to identify packet gaps identified in the stream using the PCR and the continuity counter. At 1046, each respective file writer and/or repairer monitors the MP2SPTS PCR and the continuity counter to identify a missing packet. At 1048, it is determined whether a match is found. If, at step 1048, a match is not found, then the process loops back to 1046. If, at step 1048, a match is found, then the process proceeds to step 1050, where each respective file writer and/or repairer fills in the missing packet gap in the MP2MPTS file with the matched packet. At step 1052, it is determined whether all the packet gaps identified in the capture status metadata file have been filled. If, at step 1052, it is determined that they have not all been filled, then the process loops back to step 1046. If, at step 1052, it is determined that they have all been filled, then the process proceeds to step 1054, where each respective file writer and/or repairer stops writing the media file packets up to the start of the MP2TS header with the discontinuity indicator and updates the capture status metadata file status field as complete, and the process proceeds to step 1022.

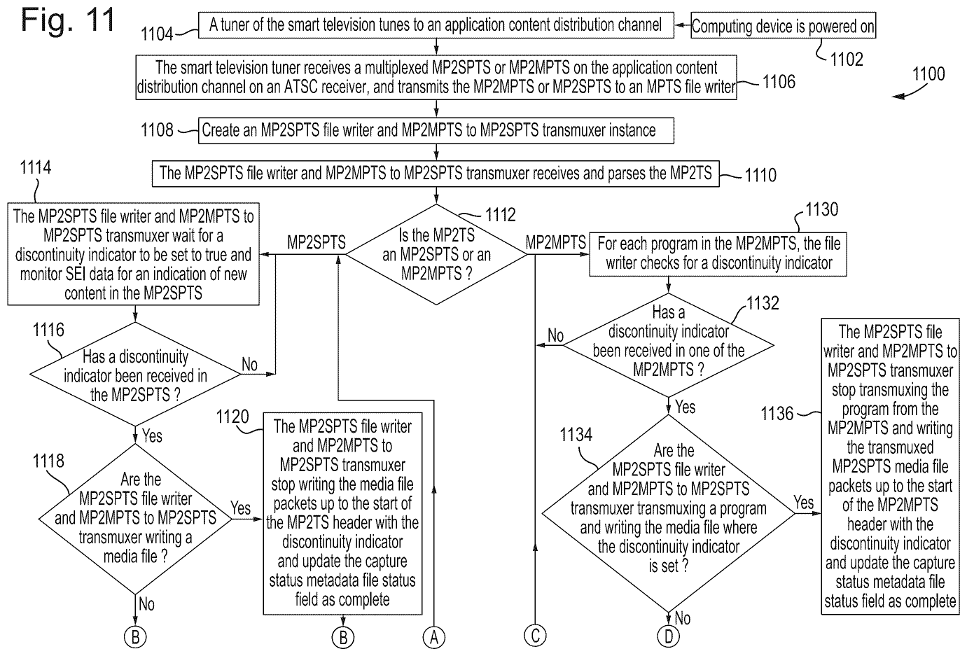

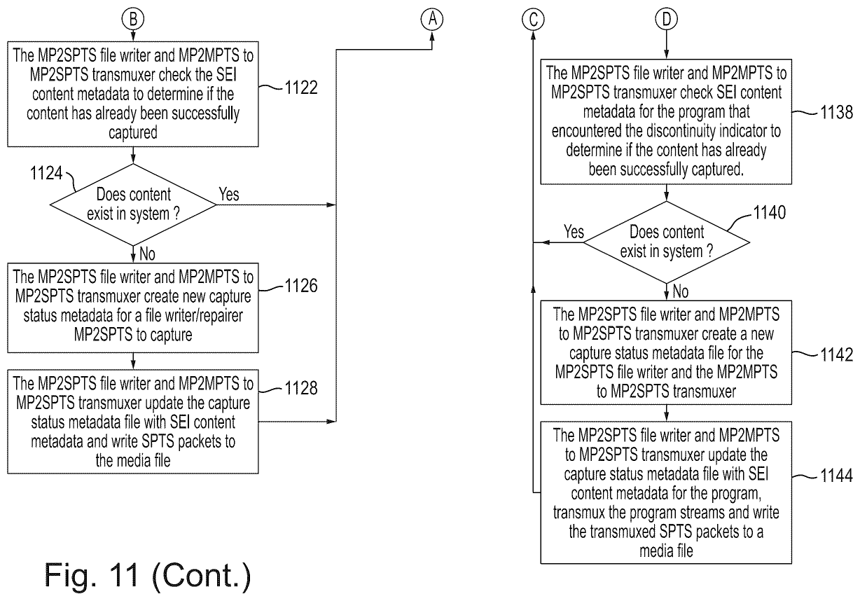

FIG. 11 shows another flowchart of illustrative steps involved in delivering application content to a computing device via a broadcast of a unidirectional stream, in accordance with some embodiments of the disclosure. The broadcast of the unidirectional stream may be via a carousel of the unidirectional stream. Process 1100 enables a dual-tuner computing device, such as a smart television, to receive an MP2MPTS stream with application content, such as VOD and/or advertisement content, and make it available through preinstalled applications on the computing device. Process 1100 may be implemented, in whole or in part, on any of the aforementioned computing devices. In addition, one or more actions of the process 1100 may be incorporated into or combined with one or more actions of any other processes or embodiments described herein.

At 1102, a computing device, such as a smart television, is powered on. At 1104, a tuner of the smart television tunes to an application content distribution channel (or frequency). At 1106, the smart television tuner receives a multiplexed MP2SPTS or MP2MPTS on the application content distribution channel on an ATSC receiver, and transmits the MP2MPTS or MP2SPTS to an MPTS file writer. At 1108, an MP2SPTS file writer and MP2MPTS to MP2SPTS transmuxer instance is created. At 1110, the MP2SPTS file writer and MP2MPTS to MP2SPTS transmuxer receives and parses the MP2TS. At 1112, it is determined whether the MP2TS is an MP2SPTS or an MP2MPTS.

If, at step 1112, it is determined that the MP2TS is an MP2SPTS, then the process proceeds to step 1114, where the MP2SPTS file writer and MP2MPTS to MP2SPTS transmuxer wait for a discontinuity indicator to be set to true and monitor SEI data for an indication of new application content in the MP2SPTS. At step 1116, it is determined whether a discontinuity indicator has been received in the MP2SPTS. If, at step 1116, a discontinuity indicator has not been received in the MP2SPTS, then the process loops back to step 1114. If, at step 1116, a discontinuity indicator has been received in the MP2SPTS, then the process proceeds to step 1118. At 1118, it is determined whether the MP2SPTS file writer and MP2MPTS to MP2SPTS transmuxer are writing a media file. If, at step 1118, it is determined that they are writing a media file, then the process proceeds to step 1120, where the MP2SPTS file writer and MP2MPTS to MP2SPTS transmuxer stop writing the media file packets up to the start of the MP2TS header with the discontinuity indicator and update the capture status metadata file status field as complete. The process proceeds to step 1122. If, at step 1118, it is determined that they are not writing a media file, the process proceeds to step 1122, where the MP2SPTS file writer and MP2MPTS to MP2SPTS transmuxer checks the SEI application content metadata to determine if the application content has already been successfully captured. At 1124, it is determined whether the application content exists in the system. If, at step 1124, it is determined that the application content already exists in the system, the process loops back to step 1114. If, at step 1124, it is determined that the application content does not already exist in the system, then the process proceeds to step 1126, where the MP2SPTS file writer and MP2MPTS to MP2SPTS transmuxer create new capture status metadata for a file writer and/or repairer MP2SPTS to capture. At step 1128, the MP2SPTS file writer and MP2MPTS to MP2SPTS transmuxer update the capture status metadata file with SEI content metadata and write SPTS packets to the media file, and the process loops back to step 1114.

If, at step 1112, it is determined that the MP2TS is an MP2MPTS, then the process proceeds to step 1130, where, for each program in the MP2MPTS, the file writer checks for a discontinuity indicator. At step 1132, it is determined whether a discontinuity indicator has been received in one of the MP2MPTSs. If, at step 1132, a discontinuity indicator has not been received in one of the MP2MPTSs, then the process loops back to step 1130. If, at step 1132, a discontinuity indicator has been received in one of the MP2MPTSs, then the process proceeds to step 1134. At 1134, it is determined whether the MP2SPTS file writer and MP2MPTS to MP2SPTS transmuxer are transmuxing a program and writing a media file where the discontinuity indicator is set. If, at step 1134, it is determined that they are writing a media file, then the process proceeds to step 1136, where the MP2SPTS file writer and MP2MPTS to MP2SPTS transmuxer stop transmuxing the program from the MP2MPTS and writing the transmuxed MP2SPTS media file packets up to the start of the MP2MPTS header with the discontinuity indicator and update the capture status metadata file status field as complete. If, at step 1134, it is determined that they are not writing a media file, the process proceeds to step 1138, where the MP2SPTS file writer and MP2MPTS to MP2SPTS transmuxer check SEI content metadata for the program that encountered the discontinuity indicator to determine if the content has already been successfully captured. At 1140, it is determined whether the application content exists in the system. If, at step 1140, it is determined that the application content already exists in the system, the process loops back to step 1130. If, at step 1140, it is determined that the application content does not already exist in the system, then the process proceeds to step 1142, where the MP2SPTS file writer and MP2MPTS to MP2SPTS transmuxer create a new capture status metadata file for the MP2SPTS file writer and the MP2MPTS to MP2SPTS transmuxer. At step 1144, the MP2SPTS file writer and MP2MPTS to MP2SPTS transmuxer update the capture status metadata file with SEI content metadata for the program, transmux the program streams and writes the transmuxed SPTS packets to a media file, and the process loops back to step 1130.

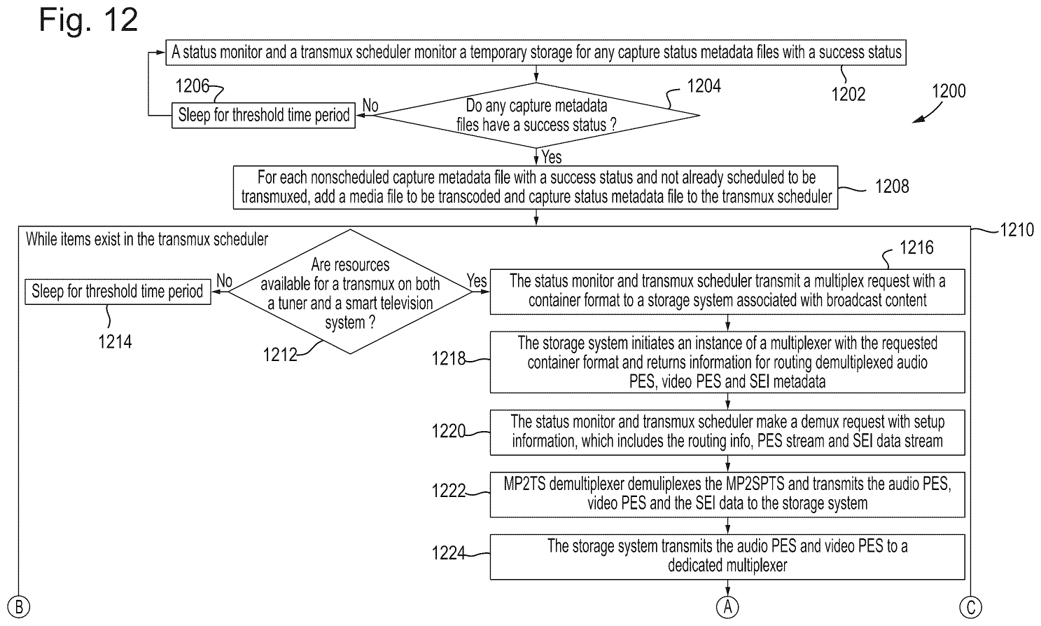

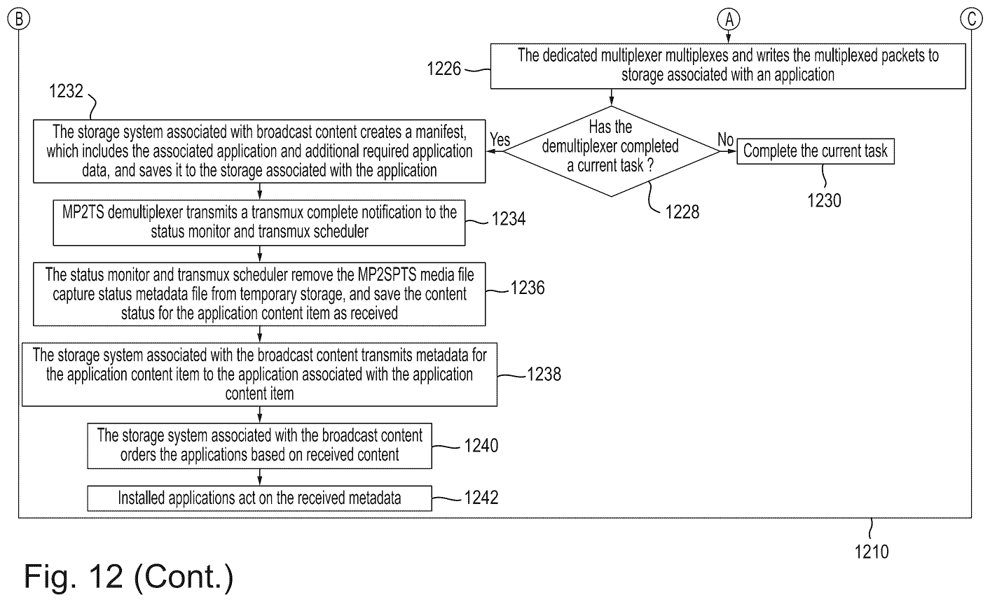

FIG. 12 shows another flowchart of illustrative steps involved in delivering application content to a computing device via a broadcast of a unidirectional stream, in accordance with some embodiments of the disclosure. The broadcast of the unidirectional stream may be via a carousel of the unidirectional stream. Process 1200 enables transmultiplexing streams in temporary storage from an MP2SPTS, and writing the transmuxed files to storage associated with an application. Process 1200 may be implemented, in whole or in part, on any of the aforementioned computing devices. In addition, one or more actions of the process 1200 may be incorporated into or combined with one or more actions of any other processes or embodiments described herein.

At 1202, a status monitor and a transmux scheduler monitor a temporary storage for any capture status metadata files with a success status, and at 1204, it is determined whether any capture metadata files have a success status. If, at step 1204, it is determined that no capture metadata files have a success status, then the process proceeds to step 1206, where the status monitor sleeps for a first threshold time period and, after the period of time has elapsed, the process loops back to step 1202. If, at step 1204, it is determined that one or more capture metadata files have a success status, then the process proceeds to step 1208, where, for each nonscheduled capture metadata file with a success status and not already scheduled to be transmuxed, a media file to be transcoded and the capture status metadata file are added to the transmux scheduler. The process proceeds to 1210, which runs while items exist in the transmux scheduler.

At 1212, it is determined whether resources are available for a transmux on both a tuner and a computing device system, such as a smart television system. If, at step 1212, it is determined that the resources are not available, then the process proceeds to step 1214, where the system sleeps for a second threshold time period. If, at step 1212, it is determined that the resources are available, then the process proceeds to step 1216, where the status monitor and transmux scheduler transmit a multiplex request with a container format, for example MP4, to a storage system associated with broadcast content, such as VOD content. At 1218, the storage system initiates an instance of a multiplexer with the requested container format and returns information for routing demultiplexed audio PES, video PES and SEI metadata. At 1220, the status monitor and transmux scheduler make a demux request with setup information, which includes the routing info, PES stream and SEI data stream. At 1222, an MP2TS demultiplexer demuliplexes the MP2SPTS and transmits the audio PES, video PES and the SEI data to the storage system. At 1224, the storage system transmits the audio PES and video PES to a dedicated multiplexer, and at 1226, the dedicated multiplexer multiplexes and writes the multiplexed packets to storage associated with an application. At 1228, it is determined whether the demultiplexer has completed a current task. If, at step 1228, it is determined that the demultiplexer has not completed the current task, then the process proceeds to step 1230, where the current task is completed.

If, at step 1228, it is determined that the demultiplexer has completed the current task, then the process proceeds to step 1232, where the storage system associated with broadcast content creates a manifest, which includes the associated application and additional required application data, and saves it to the storage associated with the application. At 1234, an MP2TS demultiplexer transmits a transmux complete notification to the status monitor and transmux scheduler. At 1236, the status monitor and transmux scheduler removes the MP2SPTS media file capture status metadata file from temporary storage, and save the content status for the application content item as received. At 1238, the storage system associated with the broadcast content transmits metadata for the application content item to the application associated with the application content item. At 1240, the storage system associated with the broadcast content orders the applications based on received content, for example, from newest to oldest. At 1242, installed applications act on the received metadata.

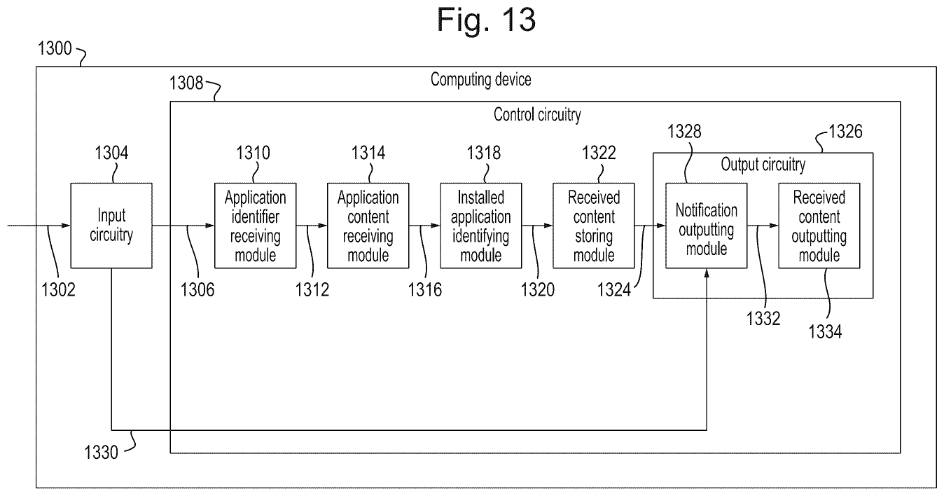

FIG. 13 shows a block diagram representing components of a computing device and dataflow therebetween for delivering application content to a computing device via a broadcast of a unidirectional stream, in accordance with some embodiments of the disclosure. The broadcast of the unidirectional stream may be via a carousel of the unidirectional stream. Computing device 1300 comprises input circuitry 1304, control circuitry 1308 and output circuitry 1326. The computing device 1300 may be, for example, a smart television. Control circuitry 1308 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 888). Some control circuits may be implemented in hardware, firmware, or software.

First input is received 1302 by the input circuitry 1304. The input circuitry 1304 is configured to receive inputs related to a computing device. For example, this may be via an infrared controller, a Bluetooth and/or Wi-Fi controller of the computing device 1300, a touchscreen, a keyboard, a mouse and/or a microphone. In another example, this may be via a gesture detected via an extended reality device. In a further example, the input may comprise instructions received via another computing device. The input circuitry 1304 transmits 1306 the user input to the control circuitry 1308.

The control circuitry 1308 comprises an application identifier receiving module 1310, an application content receiving module 1314, an installed application identifying module 1318, a received content storing module 1322, and output circuitry 1326 comprising a notification outputting module 1328 and a received content outputting module 1334. The input is transmitted to the application identifier receiving module 1310, where an application identifier is received at the computing device 1300 via a carousel of a unidirectional stream, for example, an identifier for a Disney+ application. The application identifier is transmitted 1312 to the application content receiving module 1314, where application content associated with the application identified via the application identifier is received via the carousel, for example Disney VOD content for the Disney+ application. The application identifier and the application content are transmitted 1316 to the installed application identifying module 1318, where it is identified that the application is installed at the computing device 1300, for example, that the Disney+application is installed at a smart television. The received application content is transmitted 1320 to the received content storing module 1322, where the received application content is stored at a memory associated with the computing device 1300. An indication that the content has been stored is transmitted 1324 to the output circuitry 1326, where it is received by the notification outputting module 1328, where a notification is generated for output and is output, for example, a “Watch now?” notification. Second input associated with the notification is received at the input circuitry 1304, for example, “Yes,” where it is transmitted 1330 to the notification outputting module 1328. An indication of the received input is transmitted 1332 to the received content outputting module 1334, where the received content is output at the computing device 1300, for example, received Disney VOD content is output at a display associated with the computing device 1300 via a Disney+ application.

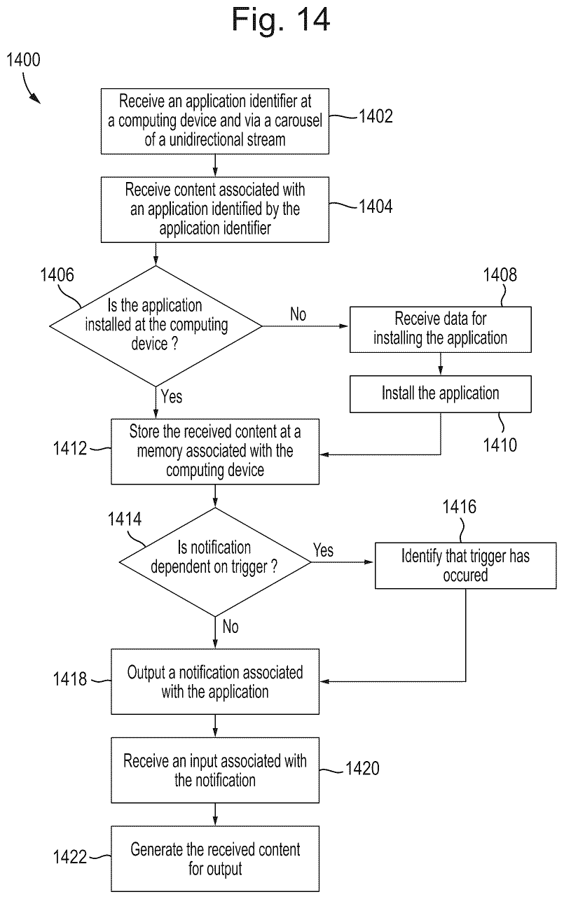

FIG. 14 shows another flowchart of illustrative steps involved in delivering application content to a computing device via a broadcast of a unidirectional stream, in accordance with some embodiments of the disclosure. The broadcast of the unidirectional stream may be via a carousel of the unidirectional stream. Process 1400 may be implemented, in whole or in part, on any of the aforementioned computing devices. In addition, one or more actions of the process 1400 may be incorporated into or combined with one or more actions of any other processes or embodiments described herein.

At 1402, an application identifier is received at a computing device and via a carousel of a unidirectional stream, and at 1404, content associated with an application identified by the application identifier is received at the computing device. At 1406, it is determined whether the identified application is installed at the computing device. If, at step 1406, if it is determined that the identified application is not installed, then the process proceeds to step 1408, where data for installing the application is received. In some examples, this data for installing the application may be received via a bidirectional stream such as via the internet. In some examples, metadata received via the unidirectional stream may comprise instructions, for example a URL, for downloading and/or installing an identified application if an internet connection is established. At 1410, the application is installed at the computing device and the process proceeds to step 1412. If, at step 1406, if it is determined that the identified application is installed, then the process proceeds to step 1412, where the received content is stored at a memory associated with the computing device. At 1414, it is determined whether a notification to be displayed is dependent on a trigger. If, at step 1414, it is determined that the notification is dependent on a trigger, or trigger condition, then, at step 1416, it is identified that the trigger, or trigger condition, has occurred, and the process proceeds to step 1418. Trigger conditions include, for example, an identified time of day, a duration of broadcast content consumption, identifying that a particular content item has been received at the computing device and/or identifying that a secondary computing device is in proximity to the computing device, for example, if it is detected that the computing device and the secondary computing device are connected to the same network. If, at step 1414, it is determined that the notification is not dependent on a trigger, or trigger condition, then the process proceeds to step 1418, where a notification associated with the application is output at the computing device. At 1420, an input associated with the notification is received, for example, via a controller and/or secondary computing device associated with the computing device. At 1422, the received content is generated for output.

In some examples, an application may be installed at the computing device; however, it may be determined that the installed application needs to be updated before, for example, the received content can be generated for display by the application. In this example, the data for updating the application may be received. In some examples, this data for updating the application may be received via a bidirectional stream such as via the internet. In some examples, metadata received via the unidirectional stream may comprise instructions, for example a URL, for downloading and/or updating an identified application if an internet connection is established. The application may then be updated at the computing device, and the received content may be generated for display by the application.

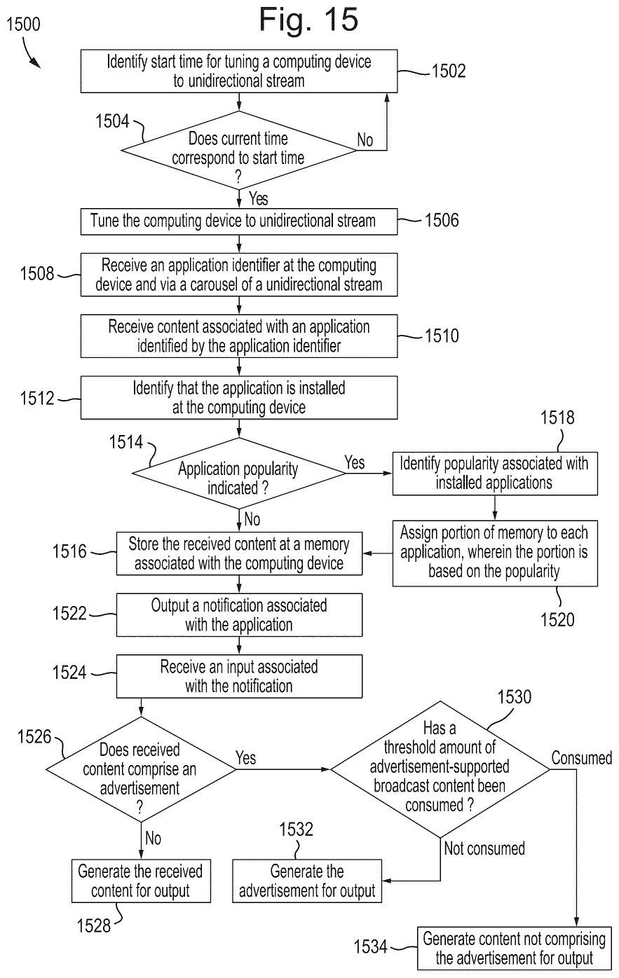

FIG. 15 shows another flowchart of illustrative steps involved in delivering application content to a computing device via a broadcast of a unidirectional stream, in accordance with some embodiments of the disclosure. The broadcast of the unidirectional stream may be via a carousel of the unidirectional stream. Process 1500 may be implemented, in whole or in part, on any of the aforementioned computing devices. In addition, one or more actions of the process 1500 may be incorporated into or combined with one or more actions of any other processes or embodiments described herein.

At 1502, a start time for tuning a computing device to a unidirectional stream is identified, for example, during a time period where the computing device may typically be idle, for example, during the hours of 1:00 a.m.-4:00 a.m. In some examples, this time period may be based on historic usage data collected at the computing device. At 1504, it is determined whether the current time corresponds to the identified start time. If it is determined that the current time does not correspond to the identified start time, then the process loops back to step 1502. In some examples, this loop may be run at periodic intervals; in other examples, this loop may be run in response to system events; and in further examples, this loop may be run continuously. If, at step 1504, it is identified that the current time corresponds to the start time, then the process proceeds to step 1506, where the computing device is tuned to a unidirectional stream. At 1508, an application identifier is received at the computing device and via a carousel of a unidirectional stream, and at 1510, content associated with an application identified by the application identifier is received. At 1512, it is identified that the application is installed at the computing device.

At step 1514, it is determined whether an application popularity is indicated, for example, via application usage data collected at the computing device. The application popularity may be based on, for example, a frequency of application usage and/or a duration of application usage. This may be local application usage and/or collated application usage from a plurality of remote users. If, at step 1514, it is determined that the application popularity is indicated, then the process proceeds to step 1518, where popularity associated with applications installed at the computing device is identified. The process proceeds to step 1520, where a portion of memory is assigned to each application, wherein the portion is based on the popularity, and the process proceeds to step 1516. If, at step 1514, it is determined that the application popularity is not indicated, then the process proceeds to step 1516, where the received content is stored at a memory associated with the computing device. At step 1522, a notification associated with the application is output at the computing device, and at step 1524, an input associated with the notification is received at the computing device.

At 1526, it is determined whether the received content comprises an advertisement. If, at step 1526, it is determined that the received content does not comprise an advertisement, then the process proceeds to step 1528, where the received content is generated for output. If, at step 1526, it is determined that the received content does comprise an advertisement, then the process proceeds to step 1530, where it is determined whether a threshold amount of advertisement-supported broadcast content has been consumed. If, at step 1530, it is determined that a threshold amount of advertisement-supported broadcast content has not been consumed then, at step 1532, the advertisement is generated for output. If, at step 1530, it is determined that a threshold amount of advertisement-supported broadcast content has been consumed then, at step 1534, content not comprising the advertisement is generated for output.

In any of the examples described herein, a computing device, such as a smart television, may be configured to transmit received application content, such as VOD content, to a secondary computing device, such as a smartphone. Both the smart television and the smartphone may have an application provided by the same provider, such as a Disney+ application, installed in order to enable the transfer of application content received at the smart television to the smartphone. This transfer may take place, for example, via a network, such as a Wi-Fi network, that the smart television and the smartphone are both connected to. In other examples, the smart television may transmit instructions for the smartphone to download the content via a received URL. For example, the smart television may receive the URL via a unidirectional broadcast and may transmit the URL to the smart phone via, for example, a Bluetooth connection. In this example, the smartphone may download the content when it is connected to a network. The smartphone may connect to a network, such as a Wi-Fi network, at a location that is different from the location of the smart television, and download the application content via a network at the different location.

In some examples, an application identifier may not be utilized in order to identify an application. A computing device, such as a smart television, may utilize automatic content recognition (ACR) (for example, via audio of a program) to identify a program that is being received at the computing device. It may be identified, via this ACR, that a program relates to a particular broadcaster, such as ABC, and that an associated application is a Disney+ application. In some examples, the smart television may utilize a local database that maps broadcasters to particular applications.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, at a computing device and via a carousel of a unidirectional stream, an application identifier;
receiving, via the carousel, content associated with an application identified by the application identifier;
identifying that the application is installed at the computing device;
storing the received content at a memory associated with the computing device;
outputting a notification associated with the application;
receiving an input associated with the notification; and
generating for output, via the application, the received content.

2. The method of claim 1, further comprising receiving, at the computing device, broadcast content via the unidirectional stream; and
wherein the application identifier identifies an application associated with the broadcast content.

3. The method of claim 1, further comprising:
identifying that the application identified by the application identifier is not installed at the computing device;
receiving data for installing the application; and
installing, via the received data and at the computing device, the application.

4. The method of claim 1, further comprising identifying a trigger for outputting the notification; and
wherein outputting the notification associated with the application further comprises outputting the notification in response to identifying that the trigger has occurred.

5. The method of claim 1, further comprising:
identifying a start time for tuning the computing device to the unidirectional stream;
identifying that a current time corresponds to the start time; and
tuning the computing device to the unidirectional stream.

6. The method of claim 1, wherein the content is first content, and storing the received first content at the memory further comprises storing the received first content to a first content file; and
the method further comprising:
receiving, at the computing device and via the carousel, a discontinuity indicator flag;
receiving, via the carousel, second content associated with the application; and
storing the received second content at the memory associated with the computing device.

7. The method of claim 1, wherein the carousel is a first carousel, and the unidirectional stream is a first unidirectional stream;
the method further comprising:
receiving the first carousel and the first unidirectional stream via a first tuner of the computing device; and
receiving, at a second tuner of the computing device, broadcast content via a second unidirectional stream.

8. The method of claim 1, wherein the unidirectional stream comprises broadcast content multiplexed with the content associated with the application; and
the method further comprising receiving, at the computing device and via the carousel, a content identifier, wherein the content identifier identifies whether each of the broadcast content and the content associated with the application should be output at the computing device or should be stored at the memory associated with the computing device.

9. The method of claim 1, further comprising:
identifying, for each of a plurality of applications installed at the computing device, a popularity associated with each installed application; and
assigning, to each of the plurality of installed applications, a portion of the memory associated with the computing device, wherein a size of each of the assigned portions is based on the popularity of a respective application.

10. The method of claim 1, wherein the received content comprises first content and second content, wherein the first content comprises an advertisement, and the second content does not comprise an advertisement;
the method further comprises identifying that a threshold amount of advertisement-supported broadcast content has been consumed at the computing device; and
generating the received content for output further comprises generating the second content for output and not the first content, based on the identification that the threshold amount of advertisement-supported broadcast content has been consumed at the computing device.

11. A system comprising:
input/output circuitry configured to:
receive an input associated with a computing device;
processing circuitry configured to:
receive, at the computing device and via a carousel of a unidirectional stream, an application identifier;
receive, via the carousel, content associated with an application identified by the application identifier;
identify that the application is installed at the computing device;
store the received content at a memory associated with the computing device;
output a notification associated with the application;
receive an input associated with the notification; and
generate for output, via the application, the received content.

12. The system of claim 11, wherein:
the processing circuitry is further configured to receive, at the computing device, broadcast content via the unidirectional stream; and
the application identifier identifies an application associated with the broadcast content.

13. The system of claim 11, wherein the processing circuitry is further configured to:
identify that the application identified by the application identifier is not installed at the computing device;
receive data for installing the application; and
install, via the received data and at the computing device, the application.

14. The system of claim 11, wherein:
the processing circuitry is further configured to identify a trigger for outputting the notification; and
the processing circuitry configured to output the notification associated with the application is further configured to output the notification in response to identifying that the trigger has occurred.

15. The system of claim 11, wherein the processing circuitry is further configured to:
identify a start time for tuning the computing device to the unidirectional stream;
identify that a current time corresponds to the start time; and
tune the computing device to the unidirectional stream.

16. The system of claim 11, wherein:
the content is first content;
the processing circuitry configured to store the received first content at the memory is further configured to store the received first content to a first content file; and
the processing circuitry is further configured to:
receive, at the computing device and via the carousel, a discontinuity indicator flag;
receive, via the carousel, second content associated with the application; and
store the received second content at the memory associated with the computing device.

17. The system of claim 11, wherein the carousel is a first carousel, and the unidirectional stream is a first unidirectional stream;
the processing circuitry further configured to:
receive the first carousel and the first unidirectional stream via a first tuner of the computing device; and
receive, at a second tuner of the computing device, broadcast content via a second unidirectional stream.

18. The system of claim 11, wherein the unidirectional stream comprises broadcast content multiplexed with the content associated with the application; and
the processing circuitry is further configured to receive, at the computing device and via the carousel, a content identifier, wherein the content identifier identifies whether each of the broadcast content and the content associated with the application should be output at the computing device or should be stored at the memory associated with the computing device.

19. The system of claim 11, wherein the processing circuitry is further configured to:
identify, for each of a plurality of applications installed at the computing device, a popularity associated with each installed application; and
assign, to each of the plurality of installed applications, a portion of the memory associated with the computing device, wherein a size of each of the assigned portions is based on the popularity of a respective application.

20. The system of claim 11, wherein the received content comprises first content and second content, wherein the first content comprises an advertisement, and the second content does not comprise an advertisement;
the processing circuitry is further configured to identify that a threshold amount of advertisement-supported broadcast content has been consumed at the computing device; and
the processing circuitry configured to generate the received content for output is further configured to generate the second content for output and not the first content, based on the identification that the threshold amount of advertisement-supported broadcast content has been consumed at the computing device.

21-50. (canceled)
